(19) United States
(12) Patent Application Publication
(10) Pub. No.: US 2017/0124645 A1
(43) Pub. Date: May 4, 2017

(54) TRUST BASED TRANSACTION SYSTEM

(71) Applicant: PAYPAL, INC., San Jose, CA (US)

(72) Inventors: Andrew Kortina, New York, NY (US); Samuel Lessin, Englewood, NJ (US); lqram Magdon-Ismail, Philadelphia, PA (US)

(21) Appl. No.: 15/374,979

(22) Filed: Dec. 9, 2016

Related U.S. Application Data
(63) Continuation of application No. 12/959,254, filed on Dec. 2, 2010.
(60) Provisional application No. 61/283,347, filed on Dec. 3, 2009.

(51) Int. Cl. G06Q 40/02; G06Q 20/40

(52) U.S. Cl. CPC G06Q 40/025; G06Q 20/405

(57) ABSTRACT

A method for applying graphs to determine creditworthiness is discussed. The method includes receiving a request for a transaction between a first and a second user. The method accesses a graph with directed edges between nodes, the directed edges indicating trusted relationships between users. First node is accessed to determine first user's risk score using weighted edges between the first node and other nodes (associated with other users). Active user ratio is determined based on number of active edges from the first node to first nodes, and on number of revoked edges from the first node to second nodes. Active edges correspond to edges between the first node and first nodes, revoked edges correspond to edges between the first node and second nodes that were removed prior to receipt of the request. Creditworthiness of the transaction is determined based on the risk score and active user ratio.

### CROSS-REFERENCE TO RELATED APPLICATIONS

This patent application is a continuation of U.S. patent application Ser. No. 12/959,254, filed Dec. 2, 2010, which claims priority benefit of U.S. Provisional Application No. 61/283,347, filed Dec. 3, 2009, both of which are incorporated by reference in their entirety.

### BACKGROUND

1. Field of Art

The disclosure generally relates to the field electronic transactions, and more particularly, electronic transactions modeled on social-economical trust.

2. Description of the Related Art

Trust between any entities, and especially individuals, is an abstract concept. It is inherently difficult to measure, represent as data, and compare in useful ways. Small businesses and individuals generally have trouble tracking, measuring and representing to each-other the complicated systems of trust which underlay their economic relationships. Conventional banks and large institutions, who play a central role in moderating an individual's or entity's trustworthiness or creditworthiness, must painstakingly design expensive and slow tools for establishing, tracking, and quantifying the trustworthiness and creditworthiness of individuals and other institutions.

However, while conventional tools built largely by banks and large institutions are untimely, slow, complicated, and expensive, their biggest issue is that they are only able to capture and quantify a small percentage of financial relationships that an individual holds with other people and institutions. For example, when attempting to establish a financial trusting relationship with a bank to receive a loan, the bank uses systems to quantify and capture a person's financial trustworthiness in a series of days by asking for references to other trusted banks and credit card issuers, employers, and service professionals. These systems have little to no ability to efficiently capture, measure, or quantify the tens or hundreds of personal financially trusting relationships possibly held by the applicant with friends, colleagues, co-workers, family members, and other institutions.

With the rise in popularity of the Internet among the general public, the emergence of Internet-based payment solutions has partially expedited some financial transactions between individuals, but it has not addressed the underlying problem of capturing, tracking, measuring, and representing the vast majority of trusted financial relationships held among individuals, nor have internet-based payment solutions expedited financial transactions between individuals and organizations based on those trusted financial relationships.

With the rise in popularity of “social networking” services among the general public, people have become accustomed to establishing both symmetrical (bi-directional) and asymmetrical (uni-directional) “friend” or “follower” relationships to indicate an informational relationship or network connection through which information can flow between people, but these links are not able to represent financial trust. “Social networking” services help users establish, represent, and measure personal “friendship” relationships and/or an informational interest in one another, they do not represent financial relationships nor do they enable any sort of financial mechanism or quantification of financial trust.

There is still no effective way using the Internet and connected mobile devices to capture, measure, represent, and quantify the personal, business, and organizational trusted financial links which are held widely within our society to establish trustworthiness and creditworthiness, as well as to increase the speed and efficiency of transactions.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one example embodiment of a computing system (or machine)

FIGS. 1a through 1f illustrate one example embodiment of an overall architecture of a trust based transaction system.

FIG. 2a illustrates an example architectural overview of a trust based transaction system.

FIG. 2b illustrates one example embodiment of states of relationships within a trust based transaction system.

FIG. 3 illustrates one example embodiment of a process for finding and creating a trusted financial link with another user.

FIG. 4 illustrates one example embodiment of a process for finding and creating a trusted financial link with a not-yet existing user.

FIGS. 5a through 5c illustrate a comparative example embodiment of a system for completing a financial transaction without and with via a trusted financial link.

FIG. 6 illustrates one example embodiment of a system for removing a trusted financial link with another user.

FIG. 7 illustrates one example embodiment of a system for allowing others to access a financial trust graph data needed to examine trustworthiness of individuals on an absolute basis and relative to a wider group.

FIG. 8 illustrates one example embodiment of a system for analyzing trustworthiness of an individual on an absolute basis and relative to a group based on the financial trust graph.

FIG. 9a illustrates one example embodiment of a system for analyzing fraud and/or evaluate trustworthiness of a given transaction, or group of transactions, based on the financial trust graph.

FIGS. 9b and 9c illustrate an example trust network for analyzing a transaction.

FIG. 10 illustrates one example embodiment of a system for extending trust or credit to individuals based on the financial trust graph.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system (and method and computer readable storage medium) that is configured to map and analyze relationships between users within a trust network to provide financial context for a transaction between at least two users that have a direct or indirect association with the trust network. In one embodiment, a trust graph is generated to calculate a trust score for every member of the trust network based on the relationships that a user establishes within the network. The scores are used to provide additional details for a transaction, e.g., to determine creditworthiness of users in a transaction.

In another embodiment, a disclosed system (and method and computer readable storage medium) determines creditworthiness for a transaction in a network of users. The system creates a user profile for each user in the network of users. The user in an asynchronous configuration is either an authorizing user or a permitted user. In a synchronous configuration, a user is both an authorizing user and a permitted user. The authorizing user authorizes a permitted user to complete a transaction without further permission once an initial permission is provided to that permitted user. A permitted user is allowed to complete a transaction with the authorizing user without receiving advance permission relative to the specific transaction. Accordingly, the system receives from an authorizing user authorization for at least one permitted user and stores this authorization with the user profile of the authorizing user and the permission for each permitted user is stored with a corresponding user profile of the permitted user.

Continuing on, the system receives details of each completed transaction from each permitted user completing a transaction. The details of each completed transaction include an identification of a transaction and an amount of the transaction with the authorizing user. The system also receives details of each failed transaction from each permitted user having a completed transaction that failed. The details of the failed transaction include an identification of the completed transaction that failed and an amount of the completed transaction that failed. The system stores the details of each completed transaction and each failed transaction with the user profile of the authorizing user and the corresponding user profile of the permitted user. In response to the details of each completed transaction and each failed transaction, the system assigns a risk score and a trust score for the authorizing user and each permitted user. The system uses this information to identify creditworthiness of a new transaction with a user having an identified relationship with at least one of the authorized user and a permitted user. The creditworthiness corresponds with the risk score and the trust score of each identified authorized user and permitted user.

### Computing Machine Architecture

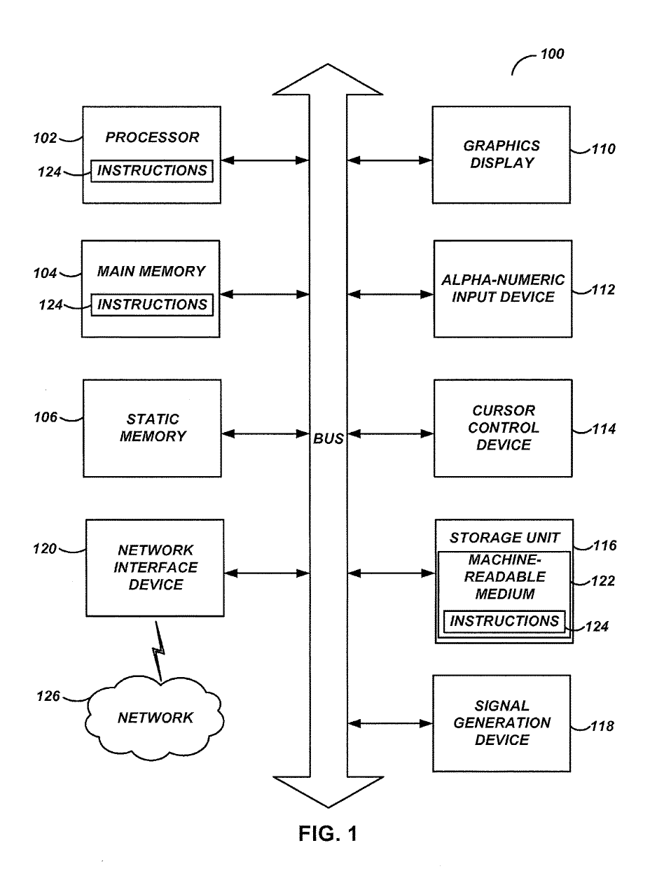

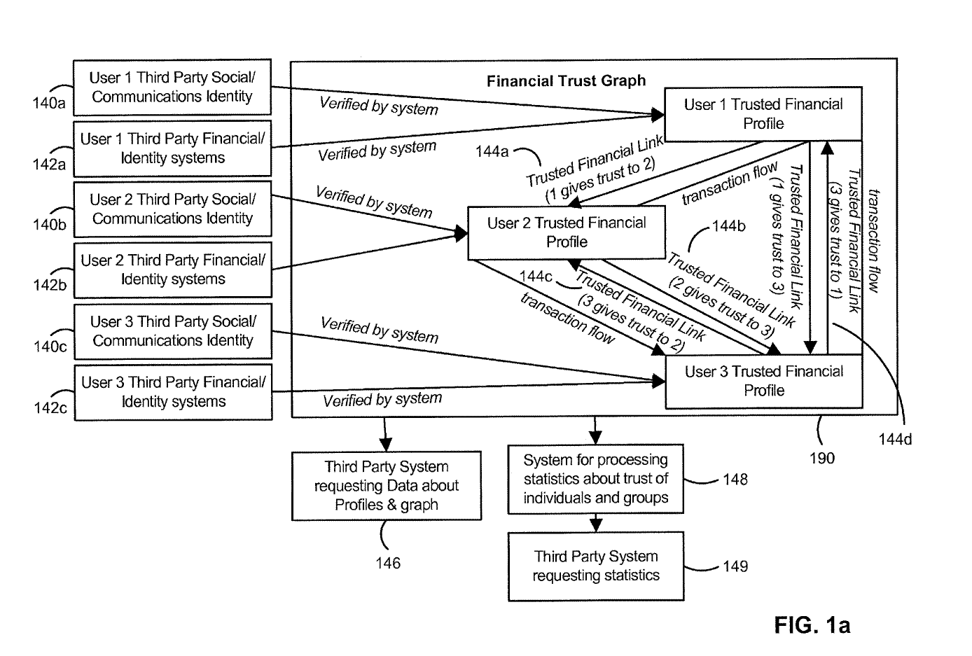

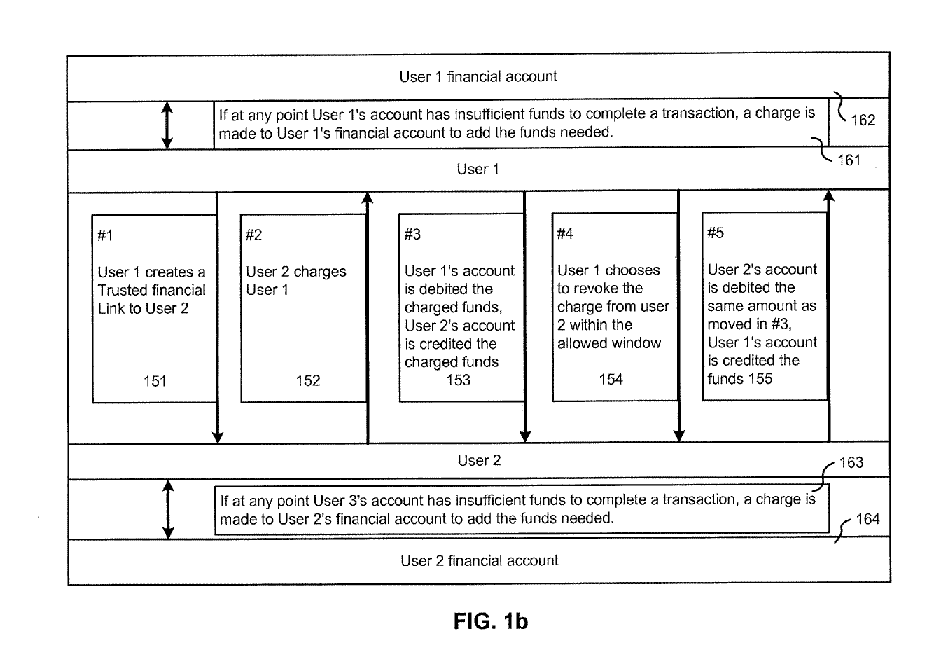

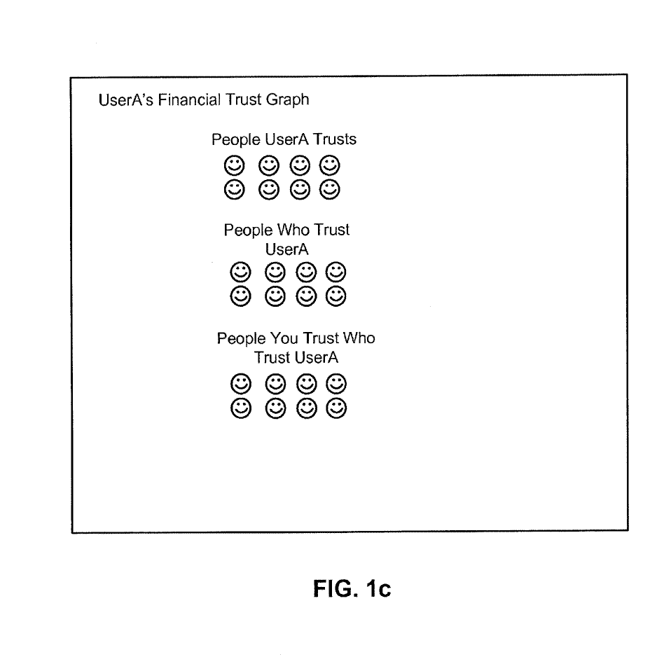

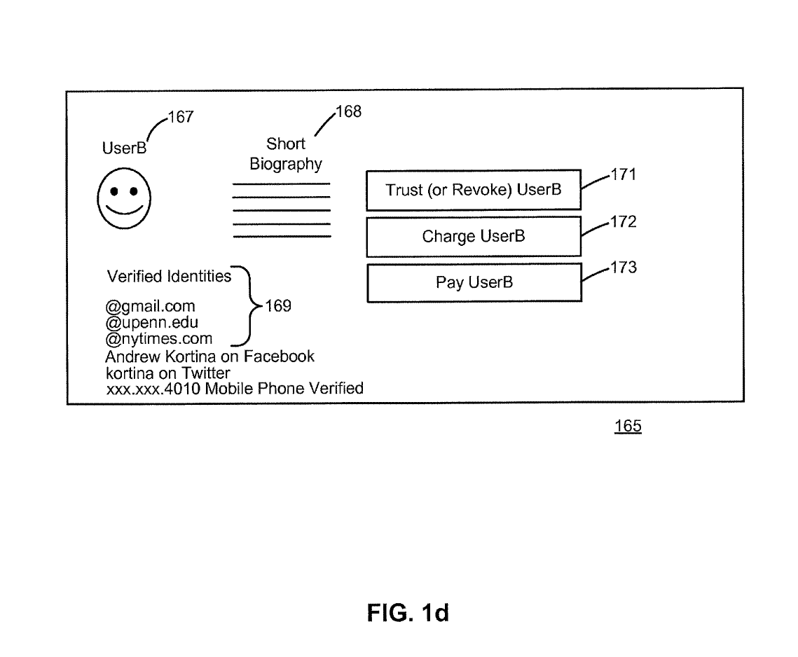

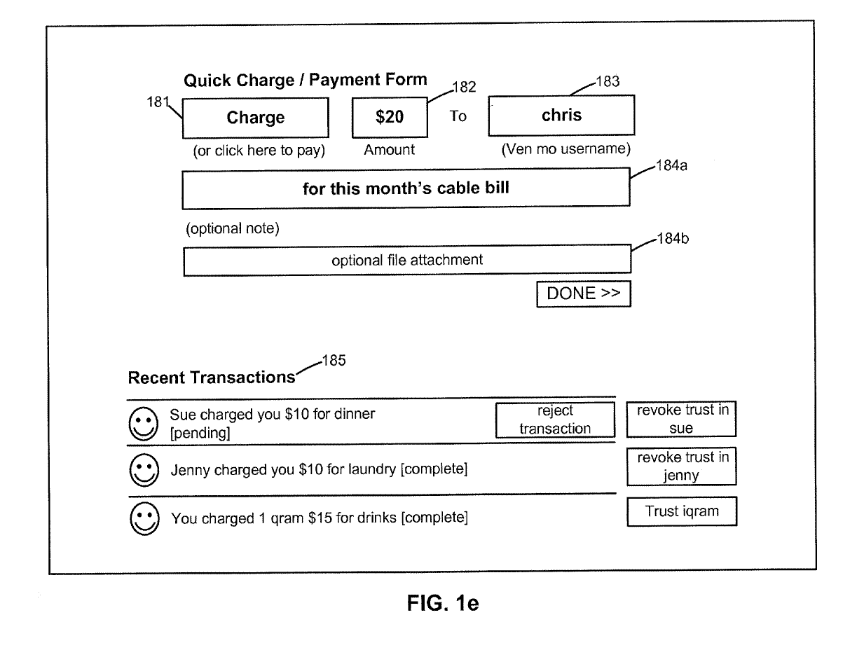

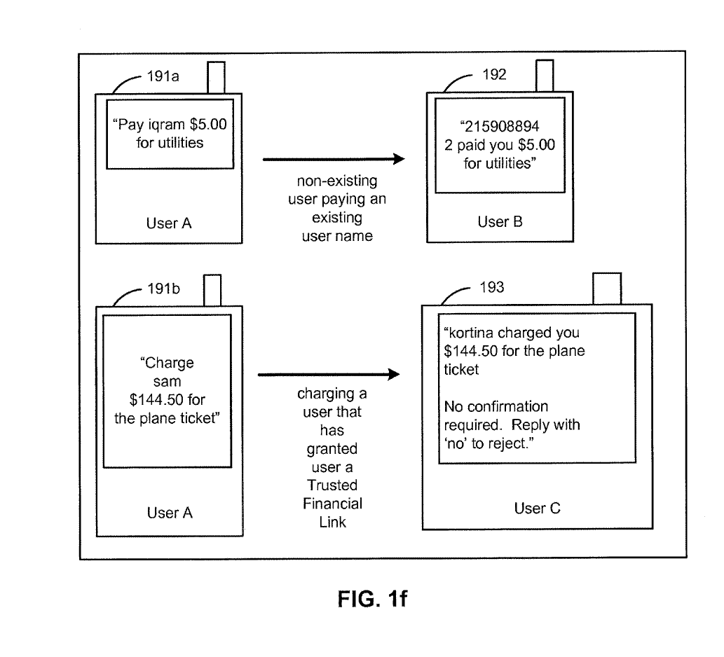

The configurations disclosed herein, including as disclosed above, are described and executable through a machine configuration. FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 820, which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### Configuring the Trust Network

A trust based transaction system may be embodied in different forms although several embodiments are based on the presence of common features. Example features are described as follows. A trusted financial profile, which includes personal and financial profiles established by users, stored in the system database (or databases), and verifiable through the system. Trusted financial links are financially trusting relationships initiated by users of the system which grant the recipient the ability to move funds from the ‘trusting’ user (or authorizing user) to their own account (permitted user). The trusted relationships may be granted to existing users on the system or to users yet to join the system in the form of invitations to create a profile. The configuration also includes formerly trusted connections, a display unit (for rendering of a user interface and part of the computing system 100), a user terminal (e.g., the computing system 100), and a database (or databases) management unit (operational within the computing system 100).

The disclosed system in one embodiment also includes a financial trust graph. The financial trust graph is a sum-total of data stored in the system database (or databases) about individuals, their relationships to other entities, and their relationships to each other via trusted financial links. The financial trust graph may be used to generate information and quantifiable statistics about the trustworthiness of individuals and groups. The system also includes financial trustworthiness algorithms based on the profiles and connections established in the system.

FIGS. 1 a through 1f illustrate one example embodiment of an overall architecture of a trust based transaction system (or trust network). The example illustrated through these figures represents one embodiment for creating a trusted financial profile from user submitted information that is verified by the system. In one embodiment, verification includes third-party social and communications identity of a user 140a-c. Examples third-party social and communication identities of a user 140a-c include domains of email accounts that a user has verified ownership of (e.g., @nytimes.com), a verified mobile phone number, or a list of third-party identities a user has verified ownership of (such as social networking services like FACEBOOK, MYSPACE, FLICKR or TWITTER).

Another source for verification used by the system is third party financial system identities of a user 142a-c, for example, a credit card transaction, a checking account history, or a conventional credit card score. Also used are trusted financial links 144a-d, which correspond to individual users having established trusted financial profiles granted (or authorizing so that user is authorizing user) to others in the system. This grant allows others (or permitted users) to ‘charge’ (in a financial arrangement) them at will. These charges can be for any purpose, for example, quick and easy bill reconciliation or short term loan and can be made open or limited by the authorizing user. The verification system also leverages a financial trust graph 190. The financial trust graph 190 comprises a sum total of all connections and interactions between and among users on the trust based transaction system.

In one example embodiment, a third party system 146, e.g., a financial institution, can interface with the financial trust graph 190 and have access to the data, profiles and graph for use in obtaining additional details in the context of completing a transaction with a user. In another example embodiment, a system can be configured 148 to interface with the financial trust graph 190 to process statistics corresponding to trust of individuals or groups of individuals linked within the financial trust graph 190.

Referring next to FIG. 1b, illustrated is an example interaction process flow between two users within the trust financial graph 190 having the trusted financial links 144a-d and transactions. In the process, user 1 has a base account 161 and a financial account 162 and user 2 has a base account 163 and a financial account 164. The base account 161, 163 may be a trust based transaction system configured account in which a user can establish a credit within the system itself. The financial account 162, 164 may be an institutional financial system account, for example, a bank checking account, a debit card account, or a credit card account. The transactions within the system occur using the base account 161, 163. However, deficiencies in the base account can be addressed through the financial accounts 162, 164 that are linked to the respective base accounts 161, 163.

In this example process flow user 1 creates 151 a trusted financial link to user 2. User 2 charges 152 user 1 in a financial transaction. The base account 161 of user 1 is debited the charged funds and the base account 163 of user 2 is credited the charged funds 153. If user 1 elects to revoke the charge from user 2 within an allowed time window 154, the base account 162 of user 2 is debited the same amount as was moved from the base account 161 of user 1 and the base account 161 of user 1 is accordingly credited 155.

FIG. 1 c illustrates an example user interface in which a user of the trust based transaction system (or trust network) can see which users trust which other users. The interface in this example reflects a trust graph for user A. Specifically, the interface illustrates people in the trust based transaction system that user A trusts, people that trust user A, and people that the person viewing (assuming they are within the trust based transaction system and logged in) that trust user A.

FIG. 1d illustrates an example graphical user interface for conducting transactions within the system, such as those described previously. When a user, e.g., user A is logged into the system and is viewing a profile page 165 of another user, e.g., user B, user A sees some basic information and a list of actions within the trust based financial system. The basic information includes identifying the user profile, e.g., user B 167, a short biography of user B 168, and identities verified 169 by the system. The list of actions includes trust (or revoke) 171 user B. Trust 171 is an option if user A does not yet trust user B and seeks to provide that authorization to charge user A. Revoke 171 is an option if user A already trusts user B, but now looks to revoke that trust authorization in user B.

Another action is charge 172 user B, which user A can select if user B trusts, and correspondingly allows, user A to charge user B. If user A is permitted to charge user B, user A will have an option to select charge 172 user B. Here, user A may fill out a form to charge user B for a specified dollar amount. In one example embodiment, if user B trusts user A, the transaction immediately occurs and user B is provided 24 hours to reject the transaction.

In an alternate example embodiment, if user B is looking to charge user A, and user A does not yet trust user B, the transaction may be queued and user A is notified that the transaction must be approved before it is completed. Here, user A may see a pay user B selection button (or switch) 173 in order to complete the transaction. In another embodiment, if user B does not trust user A, the user B may be prompted to trust user A in order to complete to transaction and establish a trusted financial link with user A.

FIG. 1 e illustrates one example user interface for a payment form. The example interface includes a selection button to charge 181, an amount to charge 182, who payment is to 183, and an optional field 184a for additional description and optional selection button to add attachments 184b. Also included in this example is a list 185 of additional transactions that were conducted by the user.

FIG. 1f illustrates yet another example embodiment of a real-time (or on the fly) transaction within the trust based transaction system. In this example, user A is using a computing system 100 that is a mobile phone. In a first instance, user A is not yet in the system, but proceeds to pay user B using a short message service (SMS) message. Specifically, user A agrees to pay user B $5.00 for utilities 191a. User B receives the SMS message that notes user A is paying $5.00 for utilities 192. The system could now prompt user B to login to the trust based transaction system to create an account. Once user B creates an account, e.g., online through a website or via a mobile phone, user B can withdraw the $5 to a checking account or send that $5 to another member within the trust based transaction system.

In a second instance, user A is part of the trust based transaction system and is charging a user C, which whom there is a trusted financial link, a charge of $144.50 for an airplane ticket 191b. User C will see the charge 193 and have an opportunity to reject the charge if so desired.

The trust graph comprises a mechanism for providing further insights on creditworthiness of a transaction between users. The subjective nature of the data corresponding to the trust graph and the trust relationships defined through it can replace and/or augment conventional objective data that is typically available to determine creditworthiness of a transaction.

### Architectural Overview

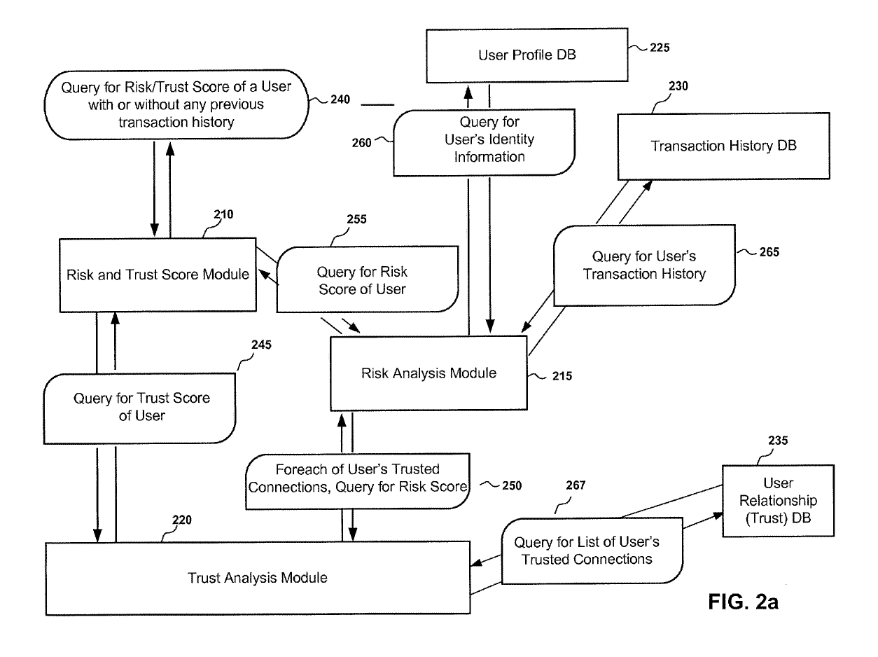

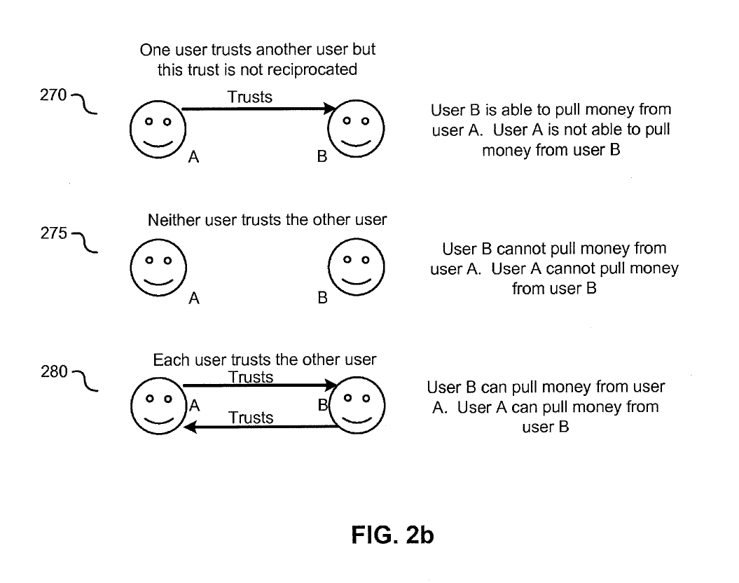

Turning now to FIG. 2a, illustrated is one example architectural overview of a trust based transaction system. The system includes a risk and trust score module 210, a risk analysis module 215, a trust analysis module 220, a user profile database 225, a transaction history database 230, and a user relationship (or trust) database 235. The risk and trust score module 210 can be a single combined module or two separate functional modules.

The communication couplings between components of the trust based transaction system can be further described here and throughout the remainder of the disclosure through its operational overview. In general, in FIG. 2a, the system can be used to query 240 the risk and trust score module 210, which determines a user risk and/or trust score with or without any previous transaction history. The trust score can be used to query 245 the trust analysis module 220 to determine trustworthiness of a given user. The trust analysis module 220 queries 267 the user relationship (or trust) database 235 to get a list of a user's trusted connections. The trust analysis database 220 queries 250 the risk analysis module 215 for a risk score for each trusted connection of the user. The information from these sources is used to determine a trustworthiness analysis of a user as further described below. The information from the trust analysis module 220 also is used to update a trust score of a user through the risk and trust score module 215.

Fed into the risk analysis module 215 is a query 255 from the risk analysis module 215 to determine a risk of a transaction with that user. The risk analysis module 215 queries 260 the user profile database 225 to receive back profile information on a user. The risk analysis module 215 also queries 265 the transaction history database 230 to get information on transactions involving the user. The information from these sources is used to determine a risk analysis of a user as further described below. The risk analysis module 215 also updates a risk score of user through the risk and trust score module 215.

### States of Relationships in a Trust Based Transaction System

FIG. 2b illustrates one example embodiment of states of relationships within a trust based transaction system having an asynchronous transaction (unidirectional). A given user, e.g., user A, can have three main states of relationship via a unidirectional trusted financial links to another user, e.g., a second user or user B. In a first state 270, one user trusts another user but the trust in not reciprocated. In this state, user B is able to pull money from user A without further authorization from user A. However, user A is not able to pull money from user B. In another example embodiment, user A can only pull money from user B without confirmation if there is a synchronous trust relationship, namely, user A trusts user B and user B trusts user A.

In a second state 275, neither user trusts the other user. In this state, user B cannot pull money from user A and user A cannot pull money from user B. In a third state 280, each user trusts the other user. In this state, user B can pull money from user A without further authorization from user A. Likewise, user A can pull money from user B without further authorization from user B.

### Establishing a Trusted Financial Profile

Initially, a user signs up through a process via various modules and links. In one embodiment the user enters into the user profile in the trust based transaction system personal profile information, for example, electronic mail address (email) or mobile telephone number. The personal profile information establishes the user's identity within the trust based transaction system. The user profile also includes a social profile, for example, details of the user's online social network or networks. The user also enters credit card or other financial profile information, for example, credit card accounts, bank accounts, and other financial transaction instruments. The financial information is verified with test authorizations and the email address is verified with a confirmation email. In another embodiment the user enters only basic personal profile information and later can provide other social and financial information. It is noted that the personal profile information can include the social profile information and/or the financial profile information and all are in the user profile.

Once the data is provided to the trust based financial system, the system transmits to the email address a verification of the trusted financial profile address. The verification email contains a uniform resource locator (URL) with a unique string and hash of the recipient email address and trust based financial system user identification (user ID). When the user visits this URL (user is only individual provided with URL), the email address is marked as verified and associated with the trusted financial profile of the user in a user profile database 225.

In an alternate embodiment, verification may occur through an SMS message. For example, if a user includes a mobile phone with the trusted financial profile, the trust based transaction system transmits a verification SMS to that phone number. The verification SMS contains a secret string or “verification code” that is stored in the user profile database 225 for the user ID of the user. The verification SMS prompts the user to reply via SMS with the verification code in the body of the SMS. When the user responds via SMS, the trust based financial system servers receive an HTTP request with the sender's phone number and the body of the SMS message. A verification application looks up user profile information in the user profile database 225 using the sender phone number. The verification application verifies that the verification code in the body of the SMS matches the code sent to the user with that phone number. If the code is correct, the phone number is marked as verified in the user profile database 225 for the trusted financial profile of the user.

Establishing Trusted Financial Links with Other Users

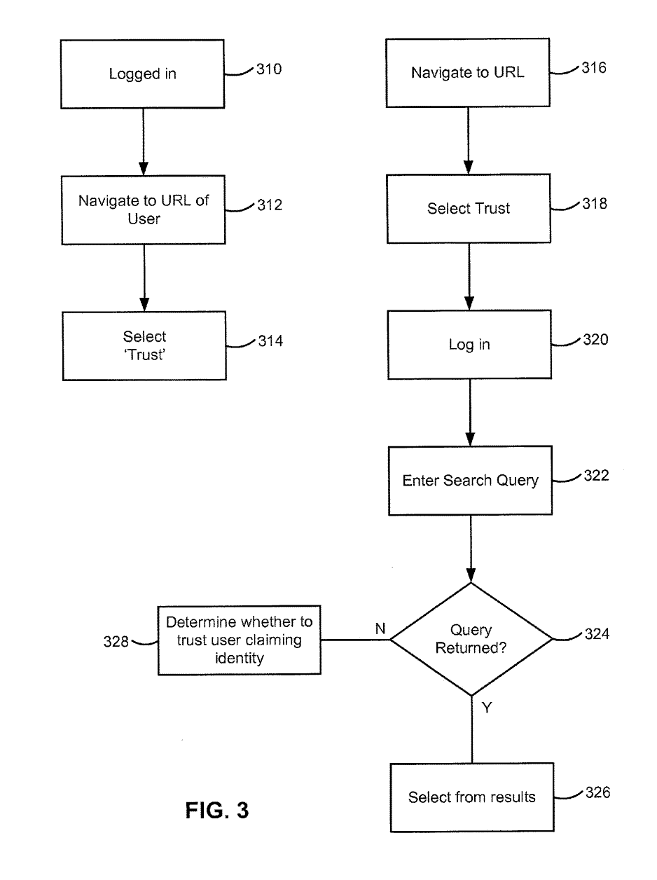

Turning now to FIG. 3, it illustrates one example embodiment of a process for finding and creating a trusted financial link with another user. A user can initiate a trusted financial link in one of a variety of ways with another user that has an account within the trust based transaction system. In one embodiment, a resulting action is that the system will establish the database record within the user profile database 225 that reflects one user, e.g., user A, trusts a specific other user, e.g., User B. Accordingly, user B will have the right to withdraw funds from user A, within the limits set by user A and/or the system. In another example embodiment, user A can only pull money from user B without confirmation if there is a synchronous trust relationship, namely, user A trusts user B and user B trusts user A. In yet another embodiment, the system will also send electronic communications to both users A and B notifying them of the establishment of the relationship and asking if they would like to take further action. In one embodiment of this action user B (who has been trusted by user A) is asked if she would like to reciprocate that trust.

While logged in 310 to the system a user, e.g., user A, (1) can navigate 312 to the ‘URL’ of another user, e.g., user B, and (2) make a selection 314 for ‘trust this person’. In one embodiment of this system the URL of user B would be in the form of http://[servicename]/[username]. Another possible embodiment of this system allows a user to navigate from the profile of one user to the profile of other users following the ‘trusted’ and ‘trusting’ links of that person to the ‘URL’ of other users.

Further, while not logged in to the system a user, e.g., user A, (1) can navigate 316 directly to the ‘URL’ of another user, e.g., user B, and (2) make a selection 318 for ‘trust this person’. User A will be asked to log in 320. While logged in to the system the user A can use a search function to query 322 the username, real name, email address, phone number, or any other identifiable personal criteria. The system will query the user relationship (or trust) database 235 and recommend likely matches based on closest match algorithms as well as system specific algorithms designed to suggest those people that user A is most likely to intend to trust who have accounts on the service.

If there are results returned 324 from the query, user A can then select 326 from the list based on the displayed results the user/users they would like to trust by clicking a button entitled ‘trust this person’. If the query does not return any result, the user A can determine 328 whether to trust whichever user claims the identity queried. Then, when user B verifies ownership of the email address, SMS, or other identity information that user specified, user A is notified which user claimed the identity trusted is now a trusted by user.

Also while logged in to the system the user, user A can input a third-party service credential, like their username and password for an email service or social network. The system will then send a request to the third party service to verify the user's credentials and to collect information about the user's associations on the third party service. The system can then recommend likely matches based on closest match algorithms as well as system specific algorithms designed to suggest those people that user A is most likely to intend to trust who have accounts on the service. The results of this query will be returned to user A who can then select from the list based on the displayed results the user/users they would like to trust by clicking a button entitled ‘trust this person’. If a user of the Third-party service listed does not yet have an associated account in the trust based transaction system, user A, who imported their connections, can choose to trust whichever user claims the identity listed. Then, when that user verifies ownership of the third-party identity user A specified, user A is notified which user claimed the identity trusted is now a trusted by user within the trust based financial system.

From a cellular telephone or other device with an immutable unique identifier a user may request to add a trusted relationship to another user by entering each other's uniquely identifying information (such as a cellular telephone number). Using the unique originating identifier of each user the trusted relationship can be established.

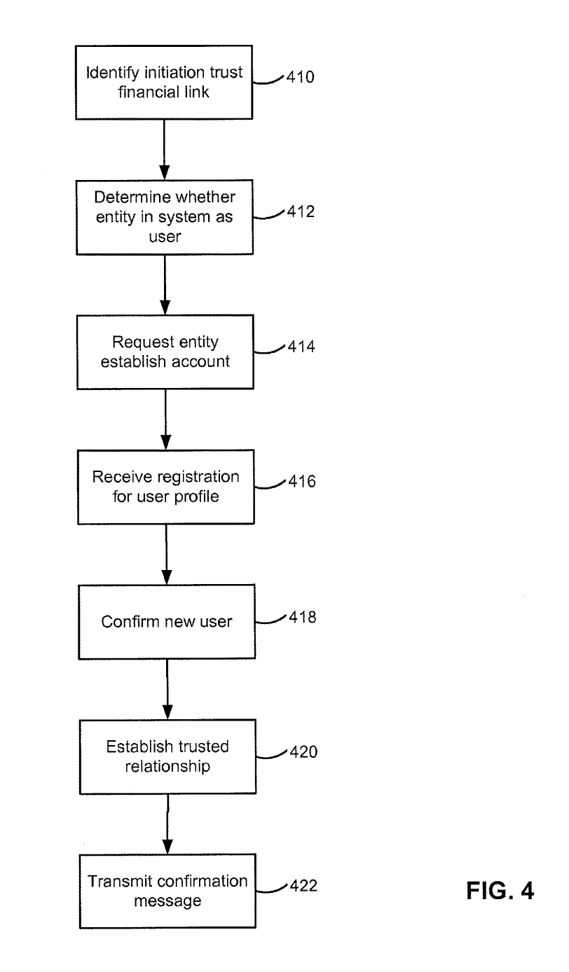

FIG. 4 illustrates one example embodiment of a process for finding and creating a trusted financial link with a not-yet existing user. For example, while logged in to the system user A can query the user profile database 225 for a specific user by entering email address, phone number, or any other uniquely identifiable personal communications handle for the entity. If the system returns that no user matches the criteria, user A is prompted to automatically invite them to the service and established a trusted relationship. In another example, while logged in to the system user A can enter the email address, phone number, or any other uniquely identifiable personal communication handle for the entity. The entity is prompted that user A wants to establish a trusted financial link with them using the trust based transaction system.

In this example, a user, e.g., user A, notifies the system to initiate 410 a trusted financial link with an entity that does not yet have an account in the trust based financial system. By way of example an entity is, for example, a person or institution that will be a new user. The trust based transaction system determines 412 whether the entity is a user. Once determined the new entity does not yet have an account in the system, the trust based transaction system transmits a request 414 to the entity to establish an account. The trust based transaction system receives 416 user profile related information to establish the entity as a new user, e.g., user B. The trust based transaction system automatically establishes 420 a trusted relationship from user A to the newly established user, e.g., user B. To confirm this, a confirmation message is transmitted 422 to both user A and now new user B.

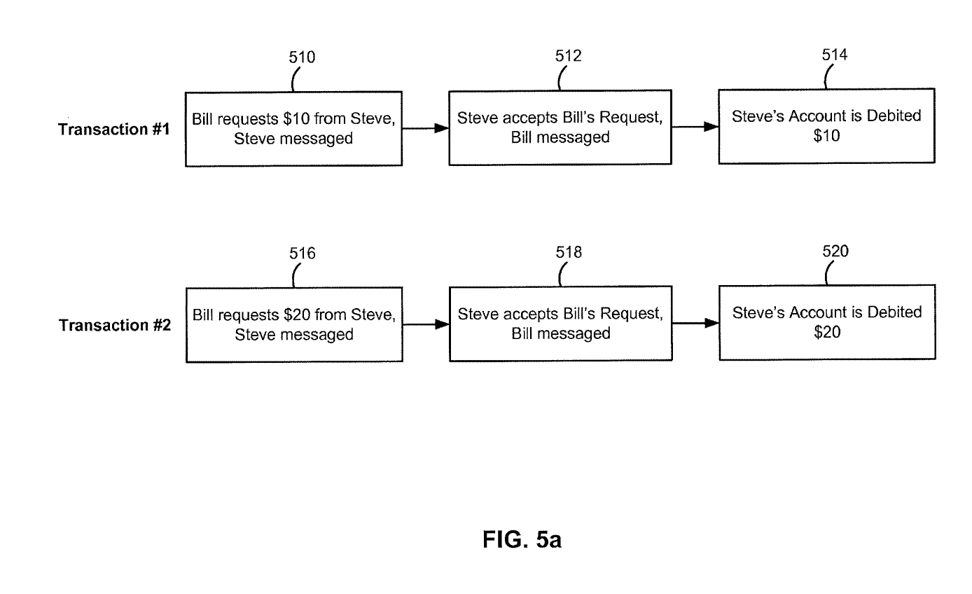

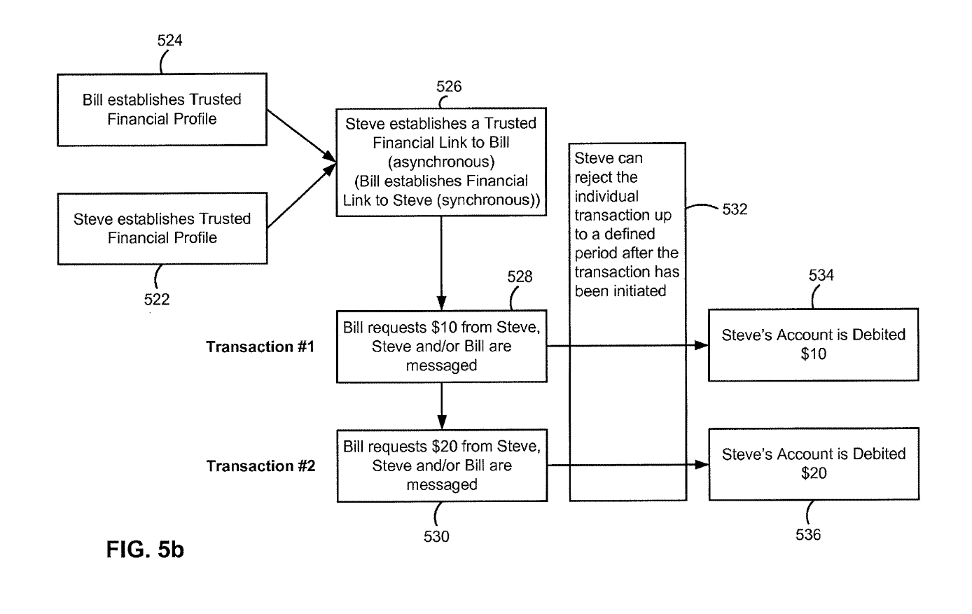

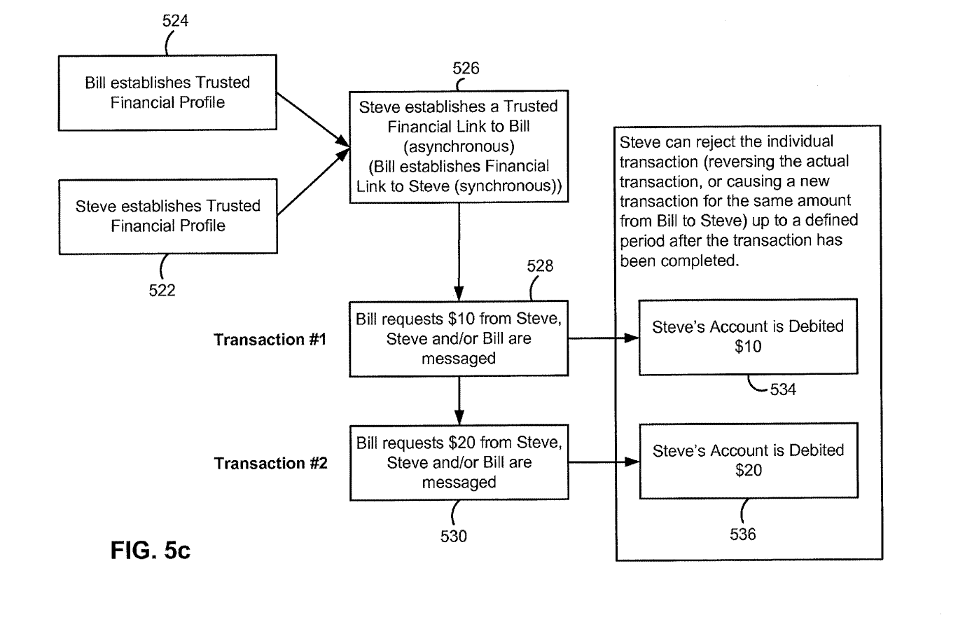

FIGS. 5a through 5c illustrate a comparative example embodiment of a system for completing a financial transaction without and with via a trusted financial link. FIG. 5a illustrates a conventional transaction in which a user, e.g., Bill, requests some money from a second user, e.g., Steve. In transaction 1, Bill requests 510 through a message money from Steve. Steve receives the message and accepts 512 Bill's request and accordingly messages Bill. Steve's account is now debited 514. Transaction 2 is similar as Bill requests 516 money from Steve and accordingly sends a message. Steve receives the message and accepts 518 Bill's request. Steve's account is then debited 520.

FIG. 5b illustrates transactions between Steve and Bill within the trust based transaction system using a trusted financial link. In this configuration, both Steve and Bill first establish a trusted financial profile 522, 524. In this example, Steve then establishes 526 a trusted financial link to Bill (an asynchronous trust). In addition, Bill may also establish 526 a trusted financial link to Steve (a synchronous trust). In one example, an asynchronous configuration is sufficient for a transaction, but in other embodiments a synchronous configuration is used for a transaction. Now, turning to transactions 1 and 2, when Bill requests 528, 530 money from Steve, the transaction is already authorized (or pre-approved) by Steve because of the trusted financial link. Accordingly, once the request is made by Bill, Steve now can decide to reject 532 the transaction up to some predefined time period, e.g., 24 hours, after the transaction is initiated. A message can be sent to Bill and/or Steve if the transaction is rejected. If the transaction is not rejected within the predetermined time period, Steve's account is debited 534, 536. It is noted that a rejected transaction may include circumstances such as an inability to cover a transaction with sufficient funds from a back account or credit limit.

It is noted that Steve may in an alternate embodiment set a predefined cap corresponding to the total of the transaction or all transactions with Bill when the trusted financial link is established. In such cases, if Bill exceeds the cap, the transaction can be automatically rejected. In yet another embodiment, Steve would have the option once the request for money is made to accept the transaction despite exceeding whatever cap may have been set.

FIG. 5c provides an example illustration of another embodiment of the transactions 1 and 2. This figure illustrates an advantage of the disclosed configuration as highly streamlined and efficient. Transactions are conducted quickly and easily due to a trusted relationship established between Steve and Bill. Moreover, the subjective nature of the data corresponding to the trust graph and the trust relationships defined through it can replace and/or augment conventional objective data that is typically available to determine creditworthiness of a transaction between these two users.

The examples in FIGS. 5b and 5c illustrates that if a user, e.g., user A (here Steve), has established a trusted financial link with another user, e.g., user B (here, Bill), user B is able to withdraw funds from user A by entering a dollar amount to be moved, and optionally a note and file attachment to explain the details of the transaction. In one embodiment, user A is notified via various mechanisms that user B has requested that funds be moved from user A to user B. A user interface within a computing system used by user A, e.g. computing system 100, a dashboard may visually depict the transaction along with supporting notes, materials, and meta-data. In one embodiment as noted, funds do not move between user accounts until after a user and or system defined window of time has passed. This may be done on an individual basis, group basis (subset of the trust based transaction system) or trust based transaction system wide basis.

Based on various system and user settings the transaction may be held as pending for a period of time during which user A may have the system default to reject the transaction, and or reject the transaction and revoke the trusted relationship they have with user B. If user A rejects the transaction and or revokes the trusted relationship with user B, user B is notified via various digital communications formats of the rejection (or rejections) and the transaction is canceled.

If during the pending period user A takes no action, then the transaction is completed, meaning that if user A has a balance within the system in excess of the requested transaction amount the requested balance are moved from user A to user B. It also may mean that if user A has a balance that is less than the requested transaction amount by user B, the system uses various mechanisms to automatically obtain the difference in funding needed to complete the transaction from user A's financial institution.

If user A's financial institutions allow the transaction to go through, the remaining difference up to the total amount requested by user B is removed from the financial institution, credited to user B's account, and then the total amount requested by user B is moved from user A's account to user B's account. If user A's financial institution rejects the transaction, then the transaction requested by user B is set to be on hold. User A and user B are notified of that the hold has been initiated. User A is prompted to add balance to their account on the system and/or update their financial information in order to complete the transaction. User B is notified that user A had insufficient funds to complete the transaction and has been asked to add the necessary funds or add the necessary financial account information to complete the transaction. Once the user has made these updates the transaction occurs as outlined above.

If user A does not update their financial information or add balance to their account, then after a period of time as set by the system and/or the users the transaction is permanently canceled. User B is notified that the transaction has been canceled. In one embodiment user A's account is suspended such that user A cannot use the system until enough information is provided to the system for the account to once again be in good standing.

If during the pending period user A rejects the transaction, the transaction as requested by user B is canceled and no funds change account. User B and user A are notified via various digital communication channels that the transaction has been canceled. In another embodiment, user A is notified via various mechanisms that user B has requested that funds be moved from user A to user B and funds are instantly moved from user A to user B. Based on system and user settings user A can reject the transaction, which causes a second transaction to instantly occur from user B to user A to reconcile accounts. If depicted on a computing system, e.g., computing system 100, used by user A, a graphical user interface, e.g., a dashboard, of the transaction is represented along with supporting notes, materials, and meta-data on an individual, group or system wide basis.

Overall, when a transaction is initiated by user B, if user A has a balance within the system in excess of the requested transaction amount the requested balance is instantly moved from user A to user B. If user A has a balance that is less than the requested transaction amount by user B, the system uses various mechanisms to automatically obtain the difference in funding needed to complete the transaction from user A's financial institution (institutions). If user A's financial institution allows the transaction to go through, the remaining difference up to the total amount requested by user B is removed from the financial institution, credited to user A's account, and then the total amount requested by user B is moved from user A's account to user B's account.

If user A's financial institution rejects the transaction, then the transaction requested by user B is set to be on hold. User A and user B are notified of that the hold has been initiated. User A is prompted to add balance to their account on the system and/or update their financial information in order to complete the transaction. User B is notified that user A had insufficient funds to complete the transaction and has been asked to add the necessary funds or add the necessary financial account information to complete the transaction. Once the user has made these updates the transaction occurs as outlined above. If user A does not update their financial information or add balance to their account, then after a period of time as set by the system and/or the users the transaction is permanently canceled. User B is notified that the transaction has been canceled. In one embodiment user A's account is suspended such that user A cannot use the system until enough information is provided to the system for the account to once again be in good standing. For each transaction all information on each step of the transaction is stored in the system transaction history database 230 with time stamps and all relevant metadata in order to facilitate credit-worthiness scoring. In one embodiment the data would be stored in a transaction history database 230 that stores details of each transaction involving the trust based transaction system. In addition, the account suspension details could be stored in a user profile database 225.

Overall, if user A rejects the transaction within the window outlined by system and user settings, then if user B has a balance within the system in excess of the rejected transaction amount the rejected balance is instantly moved from user B to user A. If user B has a balance that is less than the rejected transaction amount rejected by user A, the system obtains the difference in funding needed to complete the rejected transaction return from user B to user A from user B's financial institution (or institutions).

If user B's financial institution allows the transaction to go through, the remaining difference up to the total amount requested back by user A is removed from the financial institution, credited to user B's account, and then the total amount requested back by user A is moved from user B's account to user A's account. If user B's financial institution rejects the transaction, then the refund transaction requested by user A is set to be on hold. User B and user A are notified of that the hold has been initiated. User B is prompted to add balance to their account on the system and/or update their financial information in order to complete the transaction. User A is notified that user B had insufficient funds to complete the transaction and has been asked to add the necessary funds or add the necessary financial account information to complete the transaction. Once the user has made these updates the transaction occurs as described above.

If user B does not update their financial information or add balance to their account, then after a period of time as set by the system and/or the users the transaction is permanently canceled. User A is notified that the refund cannot be granted. In one embodiment user B's account is suspended such that user B cannot use the system until enough information is provided to the system for the account to once again be in good standing.

### Revoking Trust Relationships

At times, a user may need to remove an existed trusted relationship that was previously established. The basis for removing the trust relationship can vary, for example, disagreement between users, a change in relationship status between users, termination of employment arrangement, termination of a contractual relationship, and the like. In these example instances a user, e.g., user A, may decide to no longer want to extend trust to the other user, e.g., user B.

Once the trust relationship is revoked, e.g., user A revokes the trust relationship of user B, user B can no longer initiate charges to user A. Accordingly, the database records are updated in the user profile database 225 with the time-stamp and all other relevant meta-data about the revocation of trust, and users A and B are sent notifications of the removal of the trusted relationship.

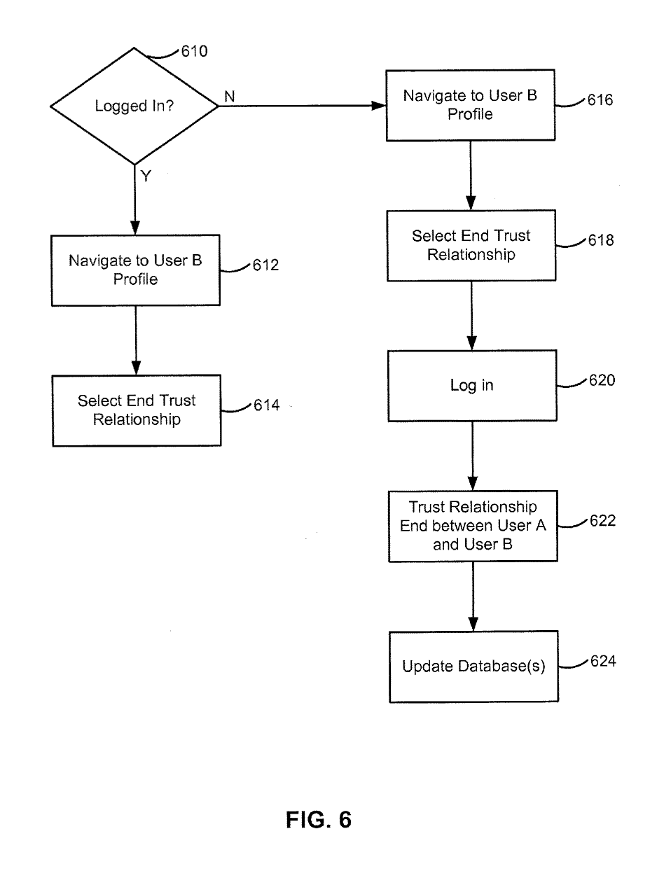

FIG. 6 illustrates one example embodiment of a system for removing a trusted financial link with another user. In this example, user A seeks to end an existing trust relationship with user B. Accordingly, the trust based transaction system determines 610, whether user A is logged into the system. If user A is logged in, user A navigates 612 to user B's profile and makes a selection 614 (e.g., on a button) corresponding to ending the trusted relationship. Once selected the trust relationship between user A and user B is ended 622 by removing the trust link between user A and user B. The trust based transaction system updates 624 the user profile of each user in the user profile database 225 and/or user relationships (or trust) database 235 to reflect this change in status between them. With the trusted financial link disabled, user A and user B now would revert to conventional transactions between them until the trusted financial link is reestablished as previously noted.

In this example, if user A is determined 610, not to be logged in, user A initially navigates 616 to user B's profile. User A makes a selection 618 (e.g., on a button) corresponding to end the trusted relationship. User A is then prompted to log in 620. Once the log in is determined to be successful, the trust based transaction system ends the trust relationship between user A and user B. The trust based transaction system updates the user profile of each user in the user profile database 225 and/or a user relationship (or trust) database 235 to reflect this change in status between them.

In alternate embodiment, other approaches may be used to end the trusted relationship. For example, from a mobile (or cellular) telephone or other device with a unique identifier, user A enters their uniquely identifying information (e.g., mobile telephone number or username) into the trust based transaction system, along with the unique identifier of user B (e.g., either manually or through a selection process on screen). Using the unique originating identifier of user A and the unique receiving identifier of user B the trust based transaction system ends the trusted relationship. Once again, the trust based transaction system updates the user profile of each user in the user profile database 225, the user relationship (or trust) database 235 and/or an external service identity database (not shown) to reflect this change in status between them.

In another embodiment, while logged in to the trust based transaction system user A may use a search function to find user B's profile by entering a variety of personally identifiable criteria. The database program returns a list of possible matches from the user profile database 225. With the match a user can be presented a selection mechanism (e.g., a button, switch, or link) corresponding to end the trusted relationship. Once the selection is received by the trust based financial system, the trusted relationship is ended by dismantling the trust link between the two users. The trust based transaction system updates the user profile of each user in the user profile database 225 and/or the user relationship (or trust) database 235 to reflect this change in status between them.

In yet another embodiment, while logged in to the system user A can examine a historical list of transactions (both completed and pending) within a user interface dashboard presented to them via the computing system 100. Next to each transaction is a selection mechanism (e.g., a button, switch or link) is enabled to end the trusted relationship. If selected, the trust based transaction system removes the trust link between user A and the selected user corresponding to the transaction associated with the selection mechanism. The trust based transaction system updates the user profile of each user in the user profile database 225 and/or user relationship (or trust) database 235 to reflect this change in status between them.

### Accessing Trustworthiness

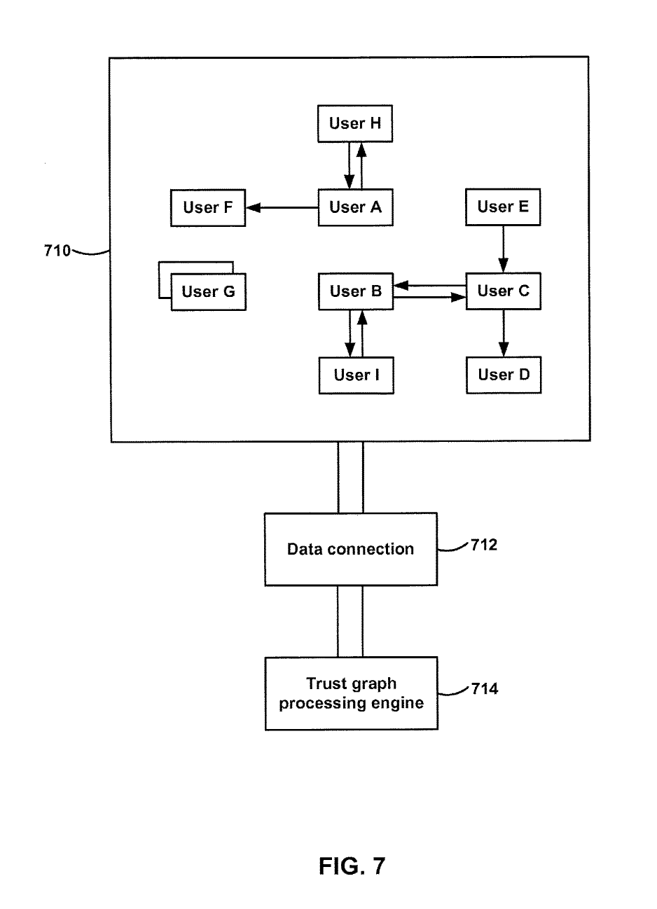

FIG. 7 illustrates one example embodiment of a system for allowing others to access trust graph data, e.g., a financial focused trust graph, to examine trustworthiness of individuals on an absolute basis and relative to a wider group. As more users integrate in with the trust based transaction system, the user trust profiles that are created and updated with personal information and financial transactions information provides insights on trustworthiness and creditworthiness not otherwise available through conventional channels, which rely solely on commonly available hard data (e.g., conventional credit reports). The combination of created and updated personal and financial information, created and updated trust relationship links (e.g., user A allows user B to withdraw money from them without further authorization), and transactions across the system, is used to generate a trust graph 710.

The trust graph 710 includes mapping the relationship between users with the trust based transaction system. The mapped relationship can be between users and the system as whole. It is noted that within the trust graph 710, each user can be referenced as a node. The nodes corresponding to each user also provide a view of a trust network within the trust based transaction system as well as trust network corresponding to any one user or group of users.

The trust graph 710 can be accessed through a data connection 712 (and corresponding application programming interface (API)) by a trust graph processing engine 714. The trust graph 710 with interface 712 for processing 714 helps create a powerful dataset that can be used to quantitatively and qualitatively examine the trustworthiness and creditworthiness of an individual in absolute or relative terms with respect to others.

In one embodiment, the trust based transactions system enables users to have access to this data to evaluate the trustworthiness of a given user. For example, in one embodiment, a user, e.g., user A, can navigate to profile page of another user, e.g., user B, and have rendered on a screen of the computer system 100, various statistics and facts. The statistics and facts allow user A to evaluate an individual creditworthiness of user B. The statistics and facts that may be available to user A include, for example, one or more of the following: (1) a number of people and identities of those who trust the user B having had established a trusted financial link to user B; (2) a number of people and identities of those who the user B trusts having established a trusted financial link from user B; (3) a number of people and identities of those whom user B and user A both trust in common having both established a trusted financial link to the same user (or users); (4) a number of people and identities of those who trust both user A and user B in common, where the same other user (or users) have established financial trust links to both user A and user B; (5) a number of people and identities of those who have revoked trust from the user B having previously established a trusted financial link to user B and then revoked it at a later date; (6) a number of people and identities of those from which the user B has revoked trust, where user B had previously established a trusted financial link to other users, and then revoked those trusted financial links at a later date; (7) a number of people and identities of those whom have revoked trust from user B who trust user A, where a set of other users currently have an established Trusted Financial Link to user A, and once had a trusted financial link to user B, but had subsequently revoked the link; (8) a number of people and identities of those whom user B has revoked trust from who user A trusts, where user B had at one point established a trusted financial link to one or many other users, but subsequently removed that trusted financial link, while user A has created and continues to maintain trusted financial link with those users; (9) a number of transactions and aggregate dollar amount the user B has successfully taken from trusting links, the total number of transactions user B has initiated and been cleared via trusted financial links granted to them by other users of the trust based financial system; (10) a number of transactions and aggregate dollar amount others have successfully taken from user B, the total number of transactions user B has allowed others to whom they have granted trusted financial links to take out of their financial accounts; (11) verified personal communications or social networking service identities that user B holds, such as email addresses at specific domains; (12) statistics about the aggregate trustworthiness of other users of the trust based transaction system to whom user B has established a trusted financial link; (13) statistics about the aggregate trustworthiness of other users of the system from whom user B has received trusted financial link; (14) statistics about the aggregate trustworthiness of associates of user B as represented on other third-party networks who use the trust based transaction system based on the above; (15) statistics about the aggregate trustworthiness of associates of user B on other networks, trusted connections, and trusting connections, based on third-party data like traditional credit scores; (16) all of the above represented over time; (17) combinations of any of the above.

In another embodiment of having statistics and data available, user A can also query the trust based transaction system about a specific user using a graphical web interface or an application programming interface (API). In one embodiment the API can be rate limited. In addition, the statistics and data may be as set forth in the examples above. In yet another embodiment, user A can query the system by searching for a specific user based on a uniquely identifying characteristic, like a phone number to retrieve any combination of the above example statistics and data.

The trust based transaction system also can be configured to enable users to request information about groups of users (or cohorts) or the overall user base at large to obtain comparisons with respect to other users or analyze general trends. For example, when logged in to the trust based financial system user A can query the system for group level statistics using a graphical web interface or an API and pass a group level identifier to pull statistics against. In one embodiment this API is rate limited. Group level statistics can include the example statistics and data previously referenced. The system also can be configured to enable users to query the system based on target values of any of the above measurements in order to have returned the trusted financial profile information of users that match the given targets.

### Analyzing Trustworthiness

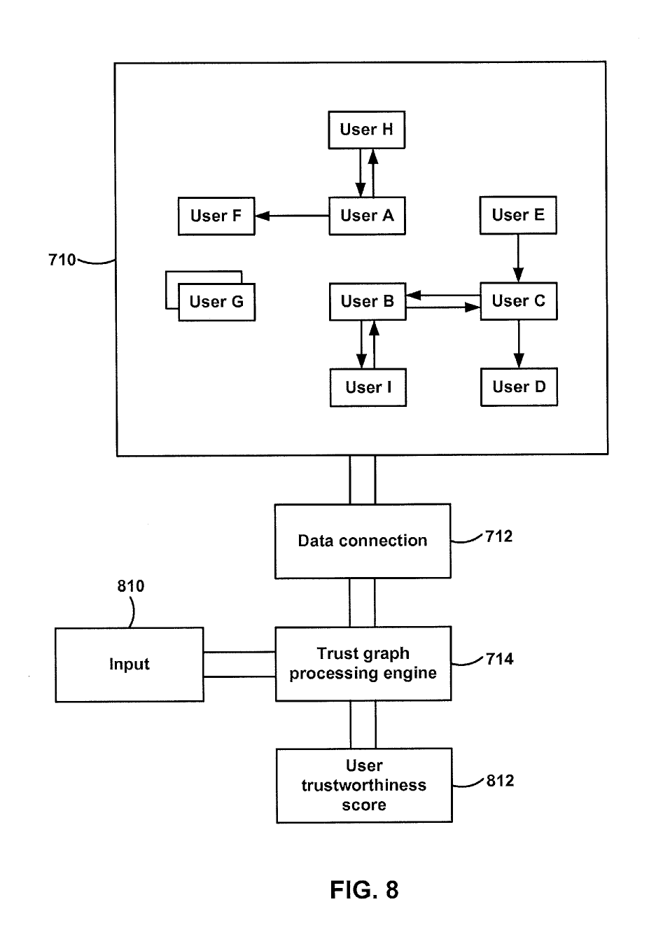

FIG. 8 illustrates one example embodiment of a trust based transaction system for analyzing trustworthiness of an individual on an absolute basis and relative to a group based on the financial trust graph. As noted previously, in aggregate the system of creating and updating trusted financial profiles with a combination of personal and financial information, creating and updating a set of trusted financial links, and transacting across the system creates a powerful data set. This data set can be used to quantitatively and qualitatively examine the trustworthiness and creditworthiness of an individual in absolute or relative to others. The sum total of this information is embodied in the financial trust graph 710.

The data provided by the financial trust graph 710 can be accessed (or provided to) the trust graph processing engine 714 through the data connection 712. The trust graph processing engine 714, executable on a computer system (e.g., computer system 100) can process the data to provide insight on statistics, trends, etc. and can provide an output for a visual (or audio) representation of the processed data.

Using an input interface 810 into the trust graph processing engine 714, additional information can be provided to the trust graph processing engine, for example, to enhance conventional data with the data provided from the trust graph 710. Consider the following example in which an entity (e.g., a third-party) evaluates whether to extend credit to a user in the trust based transaction system. The entity may have access to conventional credit scores. The conventional credit scores can be input into the trust graph processing engine 714 through the input interface 810. The conventional credit scores are unable to measure and quantify forms of social credit. Using the trust based transaction system trust graph 710 and trust graph processing engine 714, the system is able to determine a trustworthiness score 812 for a user. The trustworthiness score can be combined with the conventional credit score to provide an aggregate creditworthiness of the user.

In one embodiment, the trust graph processing engine 714 is configured to generate trustworthiness and creditworthiness scores of an individual based the trusted financial profiles and relationships drawn from the trust graph 710. Examples of such processing are provided below and may include any one or more of the example embodiments described.

In one example embodiment processing to evaluate trustworthiness and creditworthiness includes evaluating an absolute number of people that have a trusted financial link to given user. In particular, the number of people that trust a given user to have access to withdraw money from them provides a measure of social credit in a very practical and immediate sense. This number calculated in various formats can be represented to help provide insight that. In one embodiment this number is represented on an absolute scale, in a form of zero to infinity, as a number of people that trust this user.

In another example embodiment the trust graph processing engine 714 is configured to analyze an absolute number of people with which a given user has a trusted financial link. The number of people that an individual trusts to withdraw money from them represents a newly mapped form of social liability that is useful when making credit assessments. This number calculated in various formats can be represented to help provide insight that. In one embodiment this number is represented on an absolute scale, in a form of zero to infinity, as a number of people that the user trusts.

In another example embodiment, the trust graph processing engine 714 is configured to analyze a number of mutual trusted financial links. The number of people that a given person both trusts and is trusted by is an effective measure of a deeper mutual financial support bond, which is useful to understand when making credit assessments. This number calculated in various formats can be represented to help provide that insight. In one embodiment this number is represented on an absolute scale, in a form of zero to infinity, as a number of mutual trusting relationships.

In another example embodiment, the trust graph processing engine 714 is configured to analyze a ratio of mutual trusted financial links held by an individual versus one way trusted financial links held by an individual. The number of people with whom a given user has a mutual financial support bond as a percentage of the one-way trust links of others trusting the user without reciprocation, or vice versa, is yet another. In one embodiment, the ratio can be represented as a percentage from 1% to 100%.

In another example embodiment, the trust graph processing engine 714 is configured to analyze a number of revoked trusted financial links of a given user: the number of people who once trusted a given user, but removed that trust is an indicator of how much a person was once trusted versus how much they are currently trusted. This number calculated in various formats can be represented to help provide insight that. In one embodiment this number is represented on an absolute scale, in a form of zero to infinity, as a number of people that once trusted the user but no longer trust the user.

In another example embodiment, the trust graph processing engine 714 is configured to analyze a number of trusted financial links revoked by a given user. The number of people who a given user once trusted, but removed that trust is an indicator of how often a user extends trust to people they later find to be untrustworthy. This may be an indicator of a person's financial judgment or other characteristics which comprise trustworthiness. This number calculated in various formats can be represented to help provide insight that. In one embodiment this number is represented on an absolute scale, in a form of zero to infinity, as a number of people that a given user once trusted, but no longer trusts.

In another example embodiment, the trust graph processing engine 714 is configured to analyze a ratio of revoked trusted financial links to active trusted financial links. The ratio of revoked relationships to active trusted financial links, represented on a scale of 1% to 100%, is a strong indication of the relative trust.

In another example embodiment, the trust graph processing engine 714 is configured to analyze any combination of the above applied in a regressive format to the relationships of a given user as represented on the system. While understanding an individual's trustworthiness is a function of their own on and off system actions and activities, much can also be learned by understanding those with whom they associate. All of the above statistics can be run regressively on the trusted links established to a given user (1st degree), and the trusting links established from that user (1st degree), as well as the trusted and trusting links of those trusted and trusting users (2nd degree through Nth degree (N being an integer value)).

In another example embodiment, the trust graph processing engine 714 is configured to analyze any combination of the above applied in a regressive format to connections of a given user as represented on a third party service. While understanding the trustworthiness of an individual's trusted connections on the service adds a lot, it is of further value to construct the above statistics about the 1st through Nth degree network of associates that a given user associates themselves with on a third party service.

Using a combination of the service's individual trustworthiness statistics, and the web of associations represented on another external service, the same set of statistics can be run to create more information about the trustworthiness of a given individual by valuing the trustworthiness of their network of association on another service.

In another example embodiment, the trust graph processing engine 714 is configured to analyze any combination of the above applied in a regressive format to third party data about a given user on another service: while the system generates a lot of valuable data, third party services like credit rating boards, have other useful data. Using third party data and the trust based transaction system graph of trusted and trusting relationships, further statistics can be generated about the trustworthiness of an individual.

In another example embodiment, the trust graph processing engine 714 is configured to analyze any combination of the above applied in a regressive format to a third party service about other users who display other similar characteristics (cohort analysis). Any of the above statistics can be run by the system on data from third party services about like individuals or groups to imply how a similar group based on certain criteria (age, gender, marital status, location, place of employment, etc.) might behave.

In another example embodiment, the trust graph processing engine 714 is configured to analyze a ratio of any of the above: measured on a scale of 1% to 100%, the ratio of any of the above statistics can be generated by the system to generate valuable insight into the changing trustworthiness of an individual or group. In another example embodiment, the trust graph processing engine 714 is configured to analyze a rate in change in any of the above: measured as a 1% to 100% change per year, the rate of change in any of the above statistics can be generated by the system to generate valuable insight into the changing trustworthiness of an individual or group.

### Fraud Analysis and Trustworthiness of a Transaction

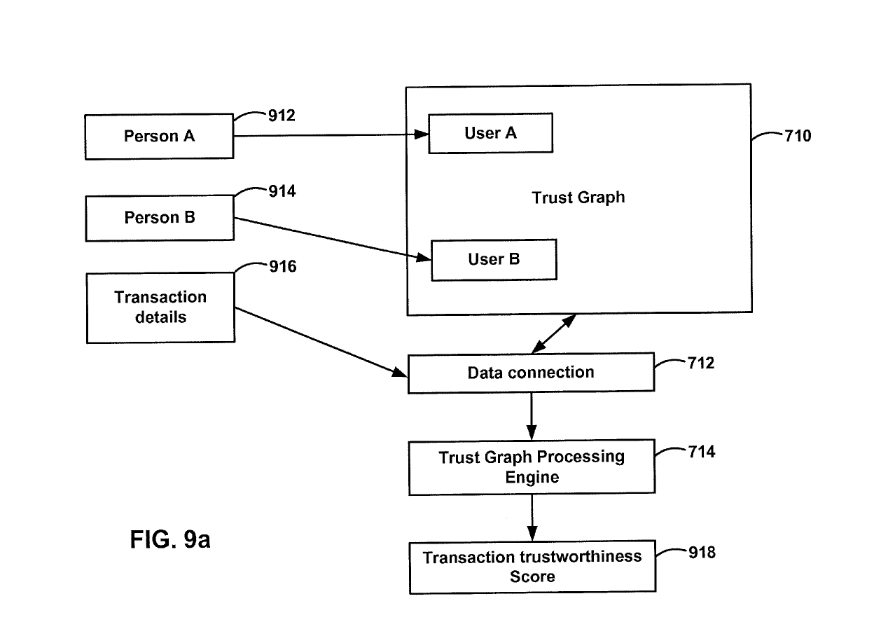

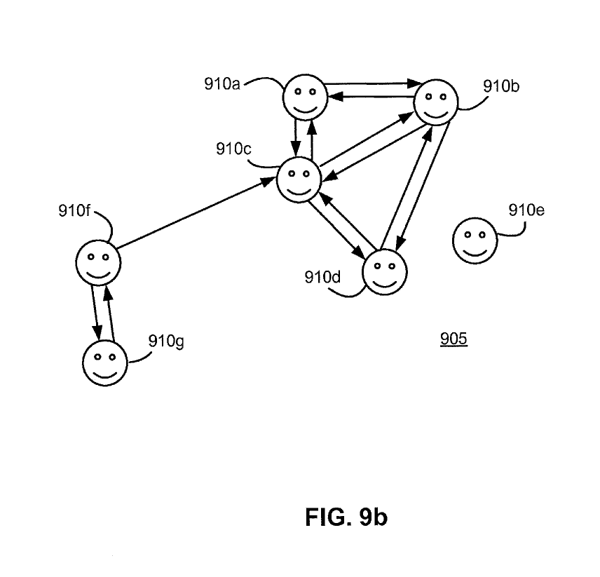

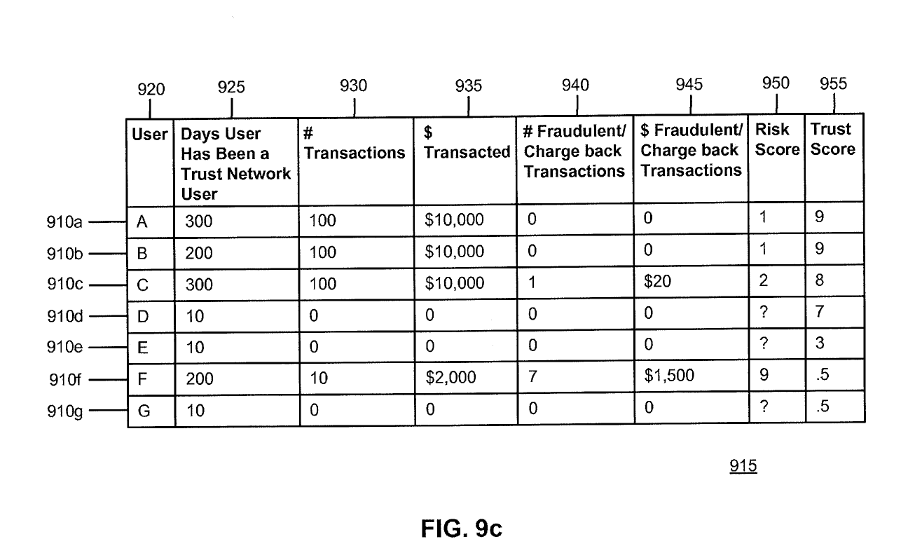

FIG. 9a illustrates one example embodiment of a system for analyzing fraud and/or evaluate trustworthiness of a given transaction, or group of transactions, based on the financial trust graph. FIG. 9a includes a truncated view (or a portion) of the trust graph 710, with user A and user B. Also illustrated is the data connection 712 and trust graph processing engine 714 In addition, FIG. 9a also shows two persons, e.g., person A 912 and person B 914, that join the trust based transaction system as user A and user B. Also shown are transaction details 916 corresponding to transactions involving users in the trust based transaction system, including user A and user B. In addition, there is a transaction trustworthiness score 918.

The trust graph 710 provides a powerful mechanism to evaluate financial transactions on an absolute basis as well as a relative basis. For example, the trust graph processing engine 714 analyzes transaction details 916 of users in the trust based transaction system with the trust graph 710 to determine a trustworthiness score 918 for a given transaction or a group of transactions within the trust based transaction system as well as beyond the system. In one example embodiment, the trust graph 710 can help detect potentially fraudulent transactions. In one embodiment, the trust based transaction system evaluates whether a particular transaction is valid by assigning a percentage likelihood of confidence level in the transactions, e.g., on a scale of 1% to 100%.

To determine confidence level in a transaction, the trust based transaction system generates and analyzes the trust graph 710 as one-time snapshot or as a progression over some predefined period of time. To assign probability of confidence within the trust graph 710, the trust based transaction system may use any combination of criteria on an absolute basis, on a relative to a full graph basis, and/or on a relative to a specific individual or population basis. Examples of criteria are provided herein.

One example criteria includes analyzing a historical number of transactions or percentage of transactions initiated by a user, e.g., user B, which were ultimately deemed fraudulent or rejected by other users. Another example criteria is a historical number of transactions or percentage of transactions initiated at the same time of day, date, physical location, and the like. Another possible criteria is a historical number of transactions or percentage of transactions with a similar user attached note or file attachment that were ultimately deemed fraudulent or rejected. Yet another example criteria is a current and/or historical similarity between the transaction initiated by the user and the user's historical transactions with other users.

Another example criteria is current and or historical similarity in transaction behavior between the one user, e.g., user A, initiating the transaction and another user, e.g., user B, that is serving as the receiving counter-party to the transaction. Another possibility is a number, percentage, or other calculation of the trusted link relationships between one user, e.g., user A, initiating the transaction and another user, e.g., user B, that is a receiving counter-party to the transaction. Still another example criteria is any calculation of the relative network closeness of the two or more transacting parties within the financial trust graph, including shared transactions, shared trusted link relationships, and degree of separation and/or density of trusted link relationships between the transacting parties or regressively the trusted financial links between and around the financial parties.

As for using the trust based transaction system beyond transactions, reference is again made to 9a for an illustrative example. In the example, if one person, e.g., person A 914, and another person, e.g., person B 916, want to complete a transaction outside of the system either on the web or in physical space, they can each submit and verify their trusted financial profiles with the trust based transaction system. Specifically, each person 914, 916 submits on their own computing system, e.g., each ones computing system 100, a uniquely identifiable piece of identity, for example, last four digits of social security number or credit card, that was previously stored in the trust based transaction system with their respective user accounts, user A and user B, along with their respective secret password or personal identification number (PIN). In addition, one or both may enter details corresponding to the transaction they are about to enter. Note that the example configuration describes a user within the trust based transaction system granting explicit access to a user outside the system to view their trust score. Accordingly, if someone has a good trust score/low risk profile in the trust based transaction system, but no traditional credit score, can now send their trust score data to a third party, e.g., a credit card company, as additional details not previously available to the third party to obtain a line of credit.

With the data entered, the trust based transaction system uses one or more criteria, for example, one or more of the example criteria, to represent back to one or both persons 912, 914, a likelihood that the transaction they are about to engage in is valid or fraudulent. In particular, the trust based transaction system analyzes the trust graph 710 and transaction details stored with the trust graph to analyze the current transaction. Even if user A and user B do not share any common trusted link relationships, and their trusted link relationships do not share any trusted link relationships, there may be other users through whom trust relationships can be analyzed and extracted for the current transaction between user A and user B. By way of example, the trust based transaction system can identify that user A trusts user X, who in turn trusts user Y, in turn trusts user Z, who has been determined to trust user B in the trust based transaction system. In this configuration people/entities outside of the trust based transaction system can be provided access to view the trust score data of a user of the trust based transaction system, assess the potential risks of engaging in a transaction with that user of the system, and based on this risk assessment decide whether or not to engage in a transaction with the user of the system.

### Computation of Risks Using a Trust Graph

As previously noted, in one embodiment the trust based transaction system is configured to generate and analyze trust graphs, e.g., trust graph 710, to provide additional context or meaning for a transaction, for example, a financial transaction between two or more users. FIGS. 9b and 9c illustrate an example of operation of the trust based transaction system in the context of a trust network to analyze a transaction. Specifically, in this example users within the trust based transaction system are identified as nodes 910a-g and are grouped into a trust network 905, similar to how a trust network between users or groups of users was described.

Each edge (arrows between nodes) in the trust network 905 represents a trust relationship between two or more particular users. Other edges between nodes 910a-g also may exist and may also have a different weighting with respect to relationship between nodes 910a-g. For example, the number of transactions between a pair of users, e.g., nodes 910a, 910c, in the trust network 205 and dollar amounts of the transactions between them may be represented as a weighted edge (e.g., based on volume or aggregate value) between these two nodes, 910a, 910c. For ease of discussion at this stage, the example only considers trust relationships as edges between nodes.

Within the trust network 905, as previously described, each user has an associated user profile. The user profile includes a profile of the user, as previously described, including transaction activities associated with the user. In addition to the information noted previously, the user profile of the user also includes publicly available, or otherwise objective or hard, information about the user, including data such as birth date, residence information, educational background, and employment information. The transaction activities include transaction information, or example, with whom transactions were conducted, an aggregate number of transactions, the value of those transactions, and how successful were the transactions (e.g., no charge backs or reversals and/or no fraud).

Although some information may not be initially present, over time, the user profile expands to include other information that may be more abstract or subjective. This can be due to the user becoming more actively engaged in direct and indirect transactions within the trust network 905. Such subjective information includes, for example, information corresponding to social networks or patterns corresponding to how transactions are occurring. One example corresponds to links between users that are shown to be highly trustworthy in financial transactions as is further described below. The subjective information corresponds to inquiries that are not easily discernable as objective data, for example, “who do I trust to take money from me,” an asynchronous inquiry, or “who trusts me to take money from them,” a synchronous inquiry.

Continuing with this example, in addition to the directed graph of the trust network 905 of FIG. 9b, FIG. 9c provides a table 915 corresponding to a transaction history of each user (node) 910a-g in the trust network 905. It is noted that the table 915 illustrated in FIG. 9c is a simplification of the data collected about each user's transaction history, sufficient for illustrating a method for calculation of a trust score for each user. For example, other data points such as the average dollar amount of each transaction, transaction velocity, and a graph of transactions with particular users could also be components of calculating the trust score. This additional data and detail provides for more comprehensiveness, but for ease of discussion a simplified configuration is explained and the concepts described are understood to apply to with the additional data and details.

The table 915 in FIG. 9c includes data organized in a user column 920, a number of days a user has been in the trust network column 925, a number of transactions conducted column 930, a sum value of all of the transactions conducted column 935, a number of fraudulent or charge back transactions column 940, a sum value of the transactions found to be failed, for example, due to fraud, credit card charge backs, or incomplete due to insufficient bank account funds column 945, a risk score column 950 and a trust score column 955. The details within the first six columns, 920-945 are used to provide the risk score and trust score that populates the last two columns, respectively, 950, 955.

The transactions columns 930, 935 correspond with successful transactions conducted by a particular user, e.g., 920a-910g, within the trust network 905. The fraudulent or charge back columns 940, 945 correspond with the failed transactions by a particular user, e.g., 920a-920g, within the trust network 905. For each user, based on their transaction history and the percentage of fraudulent or charge back transactions in which the user has been involved, a risk score is computed that depicts the frequency and volume of failed transaction versus successful transactions. Examples of failed transactions include credit card charge backs, credit card fraud, transactions not completed due to insufficient banking funds, or rejected automated clearinghouse (ACH) transactions.

A computation of the risk score depends upon a particular transaction activity of individual users within the trust network 905. In this example, the particularities of the risk score can be based on factors such as a relationship between success transactions from fraudulent transactions or total transactions and successful transactions. The relationship also may be weighted if desired. In one embodiment, reliable users are deemed to have a low risk score, and thus a likelihood of greater reliability of a successful transaction, while users that have a high percentage of failed transactions are deemed to have a high risk score, and thus a likelihood of less reliability of a successful transaction. It is noted that in the case of new user, they initially have no risk score because they have no established history within the trust network. In this instance, the risk score is not a low risk score, but rather a null.

Within the trust network 905, each user 910a-g also has a trust score 955. The trust score 955 corresponds to a representation of trustworthiness associated with that user 910a-g. The trustworthiness provides an indication of how likely it is that a funding transaction with that user will be successful. The success probability is calculated using the transaction histories of each user and their relationships within the network, for example, the number of other transactions 930 and the value of those transactions 935 carried out which involved the particular user 910a-g. This calculation takes into consideration the number 940 and value 945 of prior failed transactions (e.g., fraudulent or bounced transactions) and charge backs. Hence, the trustworthiness includes a determination of a successful transaction that is carried out without failure or chargeback of that transaction.

In one embodiment the trust score 955 is a particular user, e.g., user A 910a, is computed, for example, in one embodiment by combining the following: (1) the risk score 950 of user A 910a; (2) the risk score of each user that user A 910a trusts (edges out); (3) the risk score of each user that trusts user A 910; (4) the trust score of each user that user A 910a trusts (edges out); and (5) the trust score of each user that trusts user A 910a (edges in). It is noted that an outward edge from node A (representing user A) that points in to node B (representing user B) represents the relationship established when user A chooses to trust user B. In one embodiment, an inward edge from user A to user B represents user A having chosen to trust user B on the service. An inward edge from user A to user B represents an “unreciprocated trust relationship.” In order to complete the trust link, once the inward link to user B is created, user B must then establish an outward link back to user A by choosing to trust user A in return on the system.

A low risk score 950 for user A 910 ((1) above) indicates a high level of confidence that future transactions by user A 910a will not be rejected (e.g., due to fraud or bounced credit) and will not be charge backed. Accordingly, this will result in a high trust score 955. Likewise, a high risk score 950 indicates a higher expectation of future rejection or chargeback, and thus, a low trust score 955.

Low risk scores 950 and low trust scores 955 of users that trust user A 910a ((3) and (5) above) are indicators within the trust network 905 that contribute to a high trust score 955. In particular, a trust relationship represents a grant of access of funds from one user to another. When another user, e.g., user B, 910b, trusts user A 910a, it corresponds to a level of confidence in the creditworthiness of user A 910a by user B 910b. This confidence in the creditworthiness of user A 910a by user B 910b is captured in the trust relationship and is independent of the transaction history of user A 910a. This level of confidence for trustworthiness, and correspondingly creditworthiness, may be based upon a social relationship existing between the two users, 910a, 910b, in everyday life. For example, user B 910b may have not only objective data but also may have insights and/or knowledge of subjective data associated with user A 910, for example, knowledge of user A 910a professional skills, work ethic, or detailed academic or professional history.

By way of example, objective data is readily discernable data that is commonly available (or “tangible” or “hard”) data, for example, birth date, residence information, job title, place of employment, and education degrees. In contrast, subjective data corresponds to information about a user that is discernable based on knowledge of who a particular user is (“intangible” or “soft” data) and not just from objective, commonly available data. The subjective information is supplemental information that may reflect, for example, personally knowing who a user is, knowledge of the social networks with which the user is associated, and the subjective elements of a financial relationship (e.g., reflective of a transaction beyond the exchange of goods, services and currency or a contract and more of what a user's feelings of that transaction may be).

The trust relationship extended from user B 910b to user A 910a is an indicator of confidence when user B 910b is known to have a low risk score 950. This low risk score 950 is associated form having a large number 930 (and possibly value 935) of successful, chargeback-free transactions. Alternatively, if user B 910b had a history of frequent rejected transactions or charge backs 940 (and possibly higher value charge backs and rejections 945), the trust relationship of user B 910b with user A 910, may mean that there is greater financial risk to user B 910b. Accordingly, there is no contribution towards a higher trust score 955 for user A 910a. Moreover, the greater risks illuminated from the data on user B 910a may so that it may have a negative influence on a trust score 955 for user A 910a.

The risk score and trust score of users that user A 910a trusts ((2) and (4) above) contribute to the trust score of user A 910a as described herein. In one example embodiment, user A 910a proposes a trust relationship with a user, e.g., user B 910b. User B 910a in this example has a high trust score 955 and low risk score 950. If user B 910b does not reciprocate the proposal by user A 910a by entering into the trust relationship with user A 910a, this indicates, or provides a corresponding association, that user B 910b lacks of confidence in the financial trustworthiness of user A 910a. Accordingly, this contributes to a lower confidence in user A's 910a ability to successfully fund a charge back free transaction. Therefore, a risk score for user A 910 may be raised and a trust score may be lowered.

### Trust Scores and Application

Understanding the relationship between entities within the trust network 905 as described, an example of the relationships of trust scores for the users illustrated in FIGS. 9b and 9c are now considered. By way of example, the table 915 in FIG. 9c shows users known to have a low risk score 950 and trust relationships with other high trust score users, specifically user A 910a, user B 910b, and user C 910c. Users A 910a, B 910b, and C 910c have high trust scores 955, indicating a high confidence in successful future transactions and low expectation of charge backs and/or fraud, because they have a low risk score 950 as well as trust relationships with other high trust score users.

Next, user D 910d is an example of a user that has no known risk score, but does have trust relationships with high trust score users. User D 910d has a moderately high trust score 955, indicating a fair level of confidence in successful future transactions and fairly low expectation of charge backs and/or fraud, because user D 910d is trusted by other users with high trust scores. User E 910e is an example if a user that has neither a known risk score nor trust relationships with high trust score users. User E 910e has a base level trust score 955, indicating unknown confidence in success of future transactions and unknown expectation of likelihood of charge backs and/or fraud.

User F 910f is an example of users known to have a high risk score and unreciprocated trust relationships. Both user F's history of charge back I failed transactions and the refusal of user C to reciprocate and enter into a trust relationship of user F contribute to a low trust score 955 for user F 910f, and a high expectation of future charge backs and failed transactions from User F.

User G 910g is an example of a user that has no known risk score and has trust relationships with low trust score users. In this example, user G 910g is new in the trust network 205 and does not have any risk score 950. User G 910g does have as their sole trust relationship user F 910f, who has a high risk score 950 and low trust score 955. Accordingly, there is a high expectation that transactions with user G 910g will be fraudulent and/or be a high risk account. Therefore, user G 910g has a low trust score 955.

It is noted that in one embodiment the trust score and risk score can be saved with the user profile of each user and is a secured field that is unalterable by the user. The trust based transaction system can be configured to make one or both scores available to the particular user whose profile it is and/or other users that desire to review that user's user profile before engaging in a transaction with that user.

By way of example, one sample formula for computing both risk score based on transaction history and trust score based on the risk scores within a user's trusted network is described. In this example, for ease of discussion note that the trust score computation is considering the risk scores of connected nodes, but not the trust scores of connected nodes. In other embodiments, the trust scores of connected nodes could be incorporated.

Turning first to risk score, one example has Risk Score (RS)=WBR+WRF*NRF+WPF*DTF*(NTF/NTT)−WPNFT*((NTT−NTF)/NTT). Here, WRF is weight for recent fraudulent/chargeback transactions, NRF is the number of scored user's last n (n=a predetermined number, e.g., 10) transactions that were fraudulent/chargebacks, and WPF is weight for percentage of all scored user's transactions that were fraudulent/chargebacks. In addition, NTT is a total number of scored user's transaction on the system, NTF is the number of fraudulent/chargeback transactions scored user has ever been a party to on the system, and DTF is the total dollar amount of fraudulent/chargeback transactions by scored user. Also, WBR is the based risk weight, WPNFT is the weight for percentage number of non-fraudulent/chargeback transactions (decreases risk), and MRS is the maximum risk score.

Next, looking at trust score, in one example it is Trust Score (TS)=MTS−(WRSS*RSSU+WTEI*ATEI−WTEIR*ATEIR). Here, WTEI is weight for risk scores of users that trust the scored user, WTEIR is a weight for risk scores of users that once trusted but no longer trust the scored user, ATEI is average risk scores of users that trust the scored user, and ATEIR is average risk scores of users that once trusted but no longer trust the scored user. Further, WRSS is a weight for risk score of the scored user, RSSU is a risk score of scored user, and MTS is a maximum.

In this example of the risk score and trust score computation, a high risk score indicates a history of fraudulent transactions and high expectancy of future fraudulent transactions. In addition, in this example, a high trust score indicates a user's membership in a network of low risk users, which indicates a low expectancy of fraudulent transactions.

With the trust scores derived (or calculated), the trust network 905 can apply the trust score 955. In one embodiment the value of the trust score 955 computation can be understood in the context of a user 920 within the trust network 905 by comparing it to other scoring systems currently used to assess financial risk in extending credit to consumers. For example, a primary component used to determine credit score is credit history. The credit score provides a relatively accurate job of determining the risk of future charge backs or failed transactions with an established credit history, but does not provide or predict financial risk of extending a line of credit to a consumer with no credit history. The configuration as disclosed provides this additional insight as described above with respect to users that have no transaction history and have unknown risk scores.

Unlike traditional credit score systems, the trust score 955 calculation derives a large amount of data from relationships defined through the trust network 905 in addition to the transaction history. Using transaction histories and risk scores of other users (illustrated as nodes in the trust network 905) that are connected to a user with no known transaction history, a trust score computes the financial risk (creditworthiness) of a first time customer (with no credit history). Thus, the trust network 905 beneficially creates efficiencies by providing additional context (or meaning) for a transaction, e.g., a financial transaction, which was otherwise not defined. Hence, in one example, the trust network 905 can effectively discover creditworthy individuals with no established credit history and by providing them with a line of credit based on their network of trusted relationships.

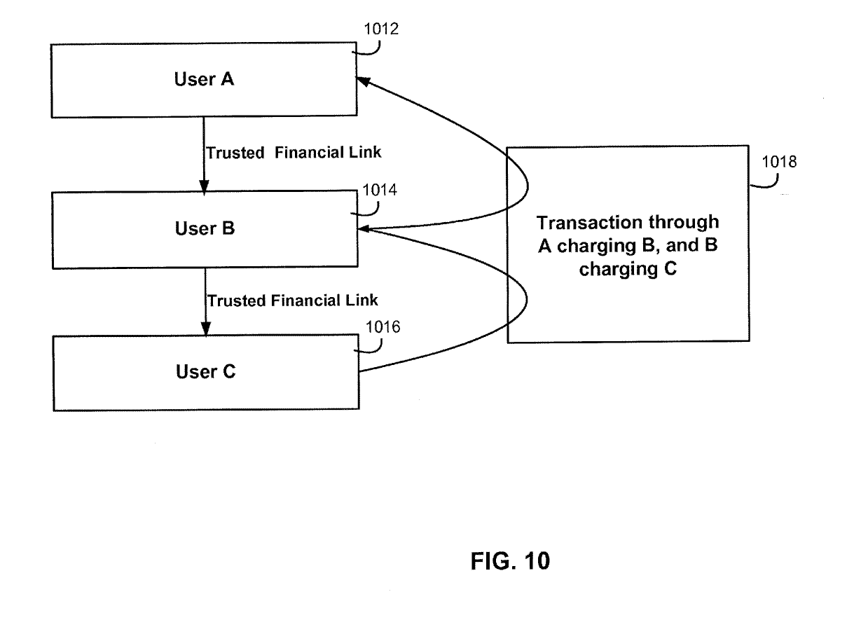

FIG. 10 illustrates one example embodiment of a system for extending trust or credit to individuals based on a trust graph that is a financial trust graph. In this example, user A 1012 has a trusted financial link with user B 1014. User B 1014 has a trusted financial link with user C 1016.

As noted previously, the financial trust graph provides a powerful mechanism for extending trust or credit lines to individual users on either an absolute basis, e.g., by a third party, or a relative basis, e.g., by users within the trust graph. In this example, user A 1012 wants to complete a transaction with user C 1016, but user C 1016 does not initially have a trusted financial link with user A 1012. The trust based transaction system queries a financial trust graph and determines that although user A 1012 and user C 1016 do not have a relationship reflecting trust within the trust graph, there are a set of users that trust user A 1012 (e.g., edges out to user B 1014) and are trusted by user C 1016 (e.g., edges in from user B 1014).

In the example embodiment, each user that is determined to be trusted by or trusting of the other user is returned as a list to user A 1012 and/or user C 1016. User A 1012 and/or user C 1016 can select on their respective computing system, e.g., computing system 100, which intermediate trusted user will be used to route the transaction. In another embodiment the trust based transaction system measures the relative strength of the trusted financial links between user A 1012 and user B by way of a set of users that have established trusted financial links to user A 1012 and to whom user C 1016 has established trusted financial links using techniques described above. The trust based transaction system then returns the suggested links to each user in the transaction to their respective computing system, e.g., computing system 100.

The transaction between user A 1012 and user C 1016 can thus be completed if allowed by trust based transaction system and user permissions by user A 1012 requesting funds from the selected intermediate user, e.g., user B 1014, that has established a trusted financial link to user A 1012 with a note and code which allows user B 1014 to then immediately get funds from user C 1016 via the trusted financial link between user B 1014 and user C 1016. Thus, the transactions between the users are settled correctly using a third trusted party within the financial trust graph. Thus, if user A 1012 and user C 1016 do not have links within the financial trust graph between them more distant degrees of relationships can be used to connect a transaction involving intermediate parties 1018. Hence, the described process provides one example corresponding to how the trust based transaction system provides a more expansive view of conducting financial transactions beyond conventional approaches.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor or processors 102, that are temporarily configured (e.g., by software) or permanently configured to perform the relevant operations, for example, FIGS. 1a-f, 3, 4, 5a, 5b, and 6 and the generation and analysis described in FIGS. 7-10. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for conducting trust based transactions based on identification and analysis of trusted relationships through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method performed for applying graphs to determine transaction creditworthiness, the method comprising:
receiving a request for a new transaction between a first user and a second user of a plurality of users;
accessing a graph that maps trusted relationships between the plurality of users, the graph with a plurality of nodes connected by a plurality of directed edges indicating types of the trusted relationships between the first user and other users;
accessing a first node in the graph to access a risk score of the first user, the first node associated with the first user, the risk score determined by accessing weights of active edges from the first node to a first subset of other nodes in the graph, the other nodes associated with the other users, the active edges corresponding to directed edges connecting the first node and nodes of the first subset;
determining, based on the graph, an active user ratio of the first user based on a number of active edges and a number of revoked edges from the first node to a second subset of the other nodes in the graph, the revoked edges corresponding to directed edges, between the first node and nodes of the second subset, that were removed prior to the receiving of the request; and
determining a creditworthiness score of the new transaction based on the risk score and the active user ratio of the first user.

2. The method of claim 1, further comprising:
receiving an authorization communication for the second user to be a permitted user, the authorization communication indicating a selection of a trust authorization toggle at a graphical user interface at a user device of the first user, the authorization communication authorizing transactions by the second user.

3. The method of claim 1, further comprising:
generating the graph based on an analysis of a history of transactions between the plurality of users, the analysis comprising determining the trusted relationships between the plurality of users based on the transactions.

4. The method of claim 1, wherein the accessing the first node is further for accessing a trust score of the first user, the trust score of the first user determined by accessing the weights of the active edges.

5. The method of claim 4, wherein the trust score of the first user is further determined by using risk scores and trust scores of a third subset of the other nodes that the graph indicates have a trusting relationship with the first node.

6. The method of claim 1, wherein the revoked edges indicate trusted relationships that were removed via the nodes of the second subset.

7. The method of claim 6, wherein the determining the creditworthiness score is further based on trust scores of the nodes of the second subset.

8. The method of claim 1, further comprising:
determining that there is no direct edge between the first node and a second node that is associated with the second user; and
determining a third node that is an intermediate node between the first node and the second node, the intermediate node connected via a first direct edge with the first node and via a second direct edge with the second node;
wherein the determining the creditworthiness score is further based on an active user ratio and the risk score of the third node.

9. The method of claim 1, wherein the accessing the first node is further for accessing a trust score of the first user, the trust score of the first user determined by accessing social information associated with the first user and with the other users.

10. A device, comprising:
a non-transitory memory storing instructions; and
a processor configured to execute the instructions to cause the device to:
receive a request for a new transaction between a first user and a second user of a plurality of users;
access a graph that maps trusted relationships between the plurality of users, the graph with a plurality of nodes connected by a plurality of directed edges indicating types of the trusted relationships between the first user and other users;
access a first node in the graph to access a trust score of the first user, the first node associated with the first user, the trust score determined by accessing weights of active edges from the first node to a first subset of other nodes in the graph, the other nodes associated with the other users, the active edges corresponding to directed edges connecting the first node and nodes of the first subset;
determine, based on the graph, an active user ratio of the first user based on a number of active edges and a number of revoked edges from the first node to a second subset of the other nodes in the graph, the revoked edges corresponding to directed edges, between the first node and nodes of the second subset, that were removed prior to the receiving of the request; and
determine a creditworthiness score of the new transaction based on the trust score and the active user ratio of the first user.

11. The device of claim 10, executing the instructions further causes the device to:
receive an authorization communication for the second user to be a permitted user, the authorization communication indicating a selection of a trust authorization toggle at a graphical user interface at a user device of the first user, the authorization communication authorizing transactions by the second user.

12. The device of claim 10, wherein the trust score of the first user is further determined by using risk scores and trust scores of a third subset of the other nodes that the graph indicates have a trusting relationship with the first node.

13. The device of claim 10, wherein the revoked edges indicate trusted relationships that were removed via the nodes of the second subset.

14. The device of claim 13, wherein the determining the creditworthiness score is further based on trust scores of the nodes of the second subset.

15. The device of claim 10, wherein executing the instructions further causes the device to,
determine that there is no direct edge between the first node and a second node that is associated with the second user; and
determine a third node that is an intermediate node between the first node and the second node, the intermediate node connected via a first direct edge with the first node and via a second direct edge with the second node;
wherein the determining the creditworthiness score is further based on an active user ratio and the trust score of the third node.

16. A non-transitory machine-readable medium having instructions stored thereon, the instructions executable to cause performance of operations comprising:
receiving a request for a new transaction between a first user and a second user of a plurality of users;
accessing a graph that maps trusted relationships between the plurality of users, the graph with a plurality of nodes connected by a plurality of directed edges indicating types of the trusted relationships between the first user and other users;
accessing a first node in the graph to access a trust score of the first user, the first node associated with the first user, the trust score determined by accessing weights of active edges from the first node to a first subset of other nodes in the graph, the other nodes associated with the other users, the active edges corresponding to directed edges connecting the first node and nodes of the first subset;
determining, based on the graph, an active user ratio of the first user based on a number of active edges and a number of revoked edges from the first node to a second subset of the other nodes in the graph, the revoked edges corresponding to directed edges, between the first node and nodes of the second subset, that were removed prior to the receiving of the request; and
determining a creditworthiness score of the new transaction based on the trust score and the active user ratio of the first user.

17. The non-transitory machine-readable medium of claim 16, wherein the operations further comprise:
receiving an authorization communication for the second user to be a permitted user, the authorization communication indicating a selection of a trust authorization toggle at a graphical user interface at a user device of the first user, the authorization communication authorizing transactions by the second user.

18. The non-transitory machine-readable medium of claim 16, wherein the trust score of the first user is further determined by using risk scores and trust scores of a third subset of the other nodes that the graph indicates have a trusting relationship with the first node.

19. The non-transitory machine-readable medium of claim 16,
wherein the revoked edges indicate trusted relationships that were removed via the nodes of the second subset, and
wherein the determining the creditworthiness score is further based on trust scores of the nodes of the second subset.

20. The non-transitory machine-readable medium of claim 16, wherein the operations further comprise:
determining that there is no direct edge between the first node and a second node that is associated with the second user; and
determining a third node that is an intermediate node between the first node and the second node, the intermediate node connected via a first direct edge with the first node and via a second direct edge with the second node;
wherein the determining the creditworthiness score is further based on an active user ratio and a trust score of the third node.
